(19) United States
(12) Patent Application Publication
(10) Pub. No.: US 2025/0332835 A1
(43) Pub. Date: Oct. 30, 2025

(54) LIQUID STORAGE APPARATUS, LIQUID STIRRING APPARATUS, AND CONTROL METHOD

(71) Applicant: CANON KABUSHIKI KAISHA, Tokyo (JP)

(72) Inventors: KOHEI FUKUI, Tokyo (JP); HIROMASA YONEYAMA, Kanagawa (JP); YUJIRO ISHIDA, Tokyo (JP); SHU KURIHARA, Tokyo (JP); MASAKAZU NAGASHIMA, Kanagawa (JP); KENTA IIMURA, Kanagawa (JP); RYOHEI MARUYAMA, Kanagawa (JP)

(21) Appl. No.: 19/184,995

(22) Filed: Apr. 21, 2025

(30) Foreign Application Priority Data
Apr. 26, 2024 (JP) 2024-072925

(51) Int. Cl. B41J 2/17; B41J 2/175; B41J 29/54

(52) U.S. Cl. CPC B41J 2/1707; B41J 2/17513; B41J 2/17523; B41J 2/17553; B41J 2/17596; B41J 29/54; B41J 2002/17516

(57) ABSTRACT

A liquid storage apparatus including: a stirring portion including a storage unit configured to store liquid and a drive unit configured to drive the storage unit; and a storage portion configured to store the stirring portion, the storage portion being opened and closed by an opening and closing member, wherein in a case where a stop condition relating to a state of the opening and closing member is satisfied, rotation of the storage unit by the drive unit is stopped.

### BACKGROUND OF THE INVENTION

### Field of the Invention

The present invention relates to a liquid storage apparatus, a liquid stirring apparatus, and a control method.

### Description of the Related Art

A liquid containing a substance susceptible to sedimentation may need to be stirred and the precipitate dispersed for use. For example, in a printing apparatus that prints by discharging liquid ink on a printing medium, when using ink such as pigment ink and metallic ink, the ink may have to be stirred to disperse the precipitate. Japanese Patent Laid-Open No. 5-338195 and Japanese Patent No. 6567186 describe an apparatus that stirs ink by spinning an ink containing unit.

### SUMMARY OF THE INVENTION

The present invention provides technology for increasing the user-friendliness of a liquid storage apparatus provided with a stirring portion for liquid.

The present invention in one aspect provides a liquid storage apparatus comprising: a stirring portion including a storage unit configured to store liquid and a drive unit configured to drive the storage unit; and a storage portion configured to store the stirring portion, the storage portion being opened and closed by an opening and closing member, wherein in a case where a stop condition relating to a state of the opening and closing member is satisfied, rotation of the storage unit by the drive unit is stopped.

The present invention can provide technology for further increasing the user-friendliness of a liquid storage apparatus provided with a stirring portion for liquid.

Further features of the present invention will become apparent from the following description of exemplary embodiments with reference to the attached drawings.

### BRIEF DESCRIPTION OF THE DRAWINGS

FIG. 1 is a perspective view of a system according to an embodiment.

FIG. 2 is a front view of the system of FIG. 1.

FIG. 3 is an explanatory diagram of the internal structure of a liquid discharge apparatus.

FIG. 4 is a front view of a storage portion.

FIG. 5 is a perspective view of a liquid storage container and a container support unit.

FIG. 6 is an explanatory diagram illustrating how the container support unit is mounted in the storage portion.

FIG. 7 is an explanatory diagram of the operation of a handle.

FIG. 8 is a perspective view of a liquid stirring apparatus.

FIG. 9 is a perspective view of the liquid stirring apparatus.

FIG. 10 is a front view of a storage space.

FIG. 11 is a diagram illustrating how the container support unit is stored.

FIG. 12 is a front view of the liquid stirring apparatus.

FIG. 13 is a perspective view of a back portion of the liquid stirring apparatus.

FIG. 14 is a diagram illustrating an example of stirring action.

FIG. 15 is an explanatory diagram of a rotation restricting unit.

FIG. 16 is a diagram illustrating a mode of rotation restriction.

FIG. 17 is a diagram illustrating a mode of rotation restriction.

FIG. 18 is an explanatory diagram of a position detection operation.

FIG. 19 is an explanatory diagram of a flow path forming member and a valve unit.

FIG. 20 is a diagram illustrating an example of changes in the orientation of the flow path forming member upon rotation.

FIG. 21 is an explanatory diagram of the arrangement of a tube fixing member on a movable side and a fixed side.

FIG. 22 is an explanatory diagram of a holding member.

FIG. 23 is a diagram illustrating an example of changes in the form of a tube and the like during rotation.

FIG. 24 is a block diagram of a control circuit of the system of FIG. 1.

FIG. 25 is an explanatory diagram of a control example.

FIG. 26 is an explanatory diagram of a control example.

FIG. 27 is an explanatory diagram of another example.

FIG. 28 is an explanatory diagram of another example.

FIG. 29 is an explanatory diagram of another example.

FIG. 30 is an explanatory diagram of another example.

FIGS. 31A and 31B are explanatory diagrams of another example.

FIGS. 32A to 32C are explanatory diagrams of another example.

FIG. 33 is an explanatory diagram of another example.

FIG. 34 is an explanatory diagram of another example.

FIG. 35 is a flowchart illustrating a processing example of a control unit.

FIGS. 36A to 36C are flowcharts illustrating processing examples of the control unit.

FIG. 37 is an explanatory diagram of another example.

FIG. 38 is an explanatory diagram of another example.

FIG. 39 is an explanatory diagram of another example.

FIGS. 40A and 40B are flowcharts illustrating a processing example of a control unit.

FIG. 41 is a flowchart illustrating a processing example of a control unit.

FIG. 42 is a flowchart illustrating a processing example of a control unit.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

There is a demand for an increase in the user-friendliness of liquid storage apparatuses provided with a liquid stirring mechanism.

According to the present invention, the user-friendliness of a liquid storage apparatus provided with a stirring portion for liquid can be increased.

### First Embodiment

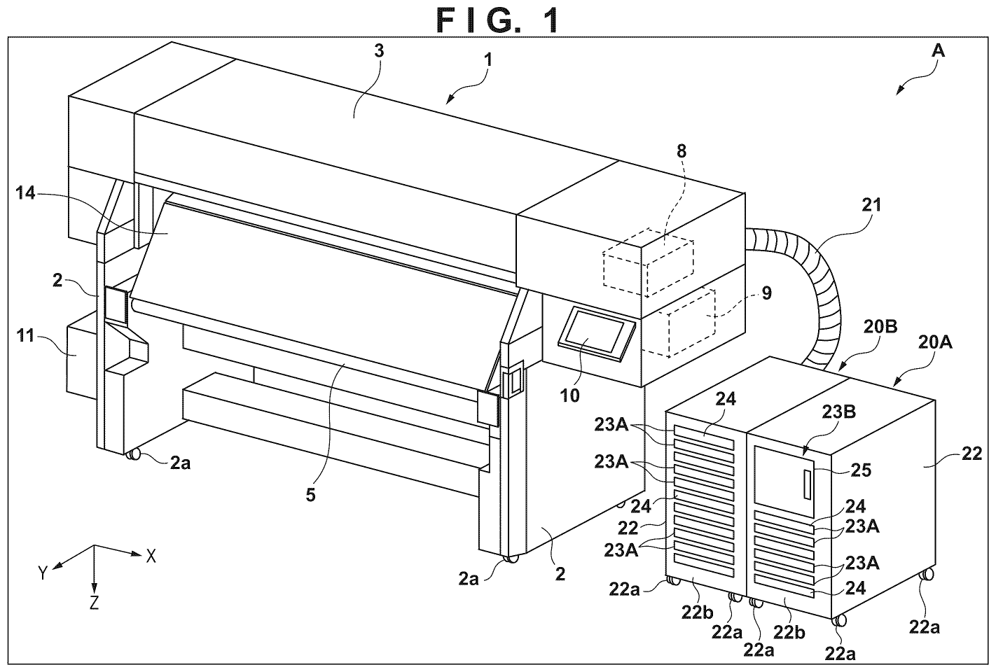

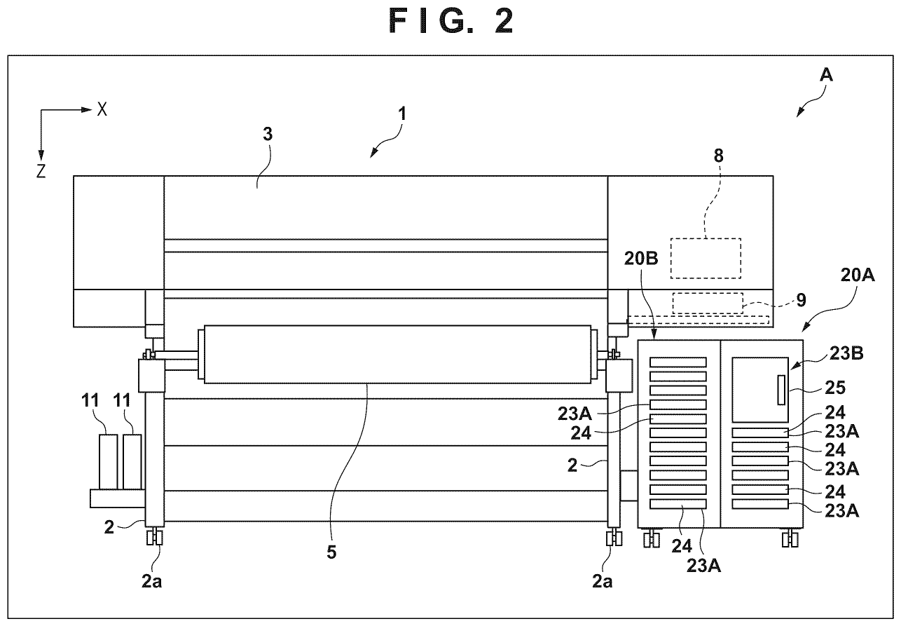

FIG. 1 is a perspective view of a system A according to an embodiment of the present invention, and FIG. 2 is a front view of the system A. In the drawings, arrows X, Y, and Z indicate intersecting directions, and in the present embodiment, these directions are orthogonal to one another. With the system A placed on a horizontal surface, the left-and-right direction corresponds to the X direction, the front-and-back direction corresponds to the Y direction, and the up-and-down direction corresponds to the Z direction. The X direction and the Y direction may also be referred to as the horizontal direction.

The system A according to the present embodiment is a printing system that includes a liquid discharge apparatus 1 and liquid storage apparatuses 20A and 20B and prints images by discharging ink on a printing medium such as paper. In the case of the present embodiment, the two liquid storage apparatuses 20A and 20B are provided. The liquid discharge apparatus 1 and the two liquid storage apparatuses 20A and 20B are placed side by side in the X direction. The liquid supplied to the liquid discharge apparatus 1 by the liquid storage apparatuses 20A and 20B is mainly ink, and the liquid discharge apparatus 1 is a printing apparatus that discharges ink onto a printing medium. However, the present invention is not limited to a printing system and may be applied to various types of liquid discharge systems that are used to discharge a liquid onto a medium.

Note that “printing” means not only forming meaningful information such as characters and shapes, but also has a broader meaning of forming images, designs, patterns, and the like on a printing medium regardless of meaning, as well as meaning editing a medium. It does not matter whether or not what is formed is a manifestation to be visually perceived by a human. Also, in the present embodiment, “printing medium” is assumed to be a sheet-like piece of paper, but cloth, plastic, film, and the like may be used.

### Liquid Discharge Apparatus

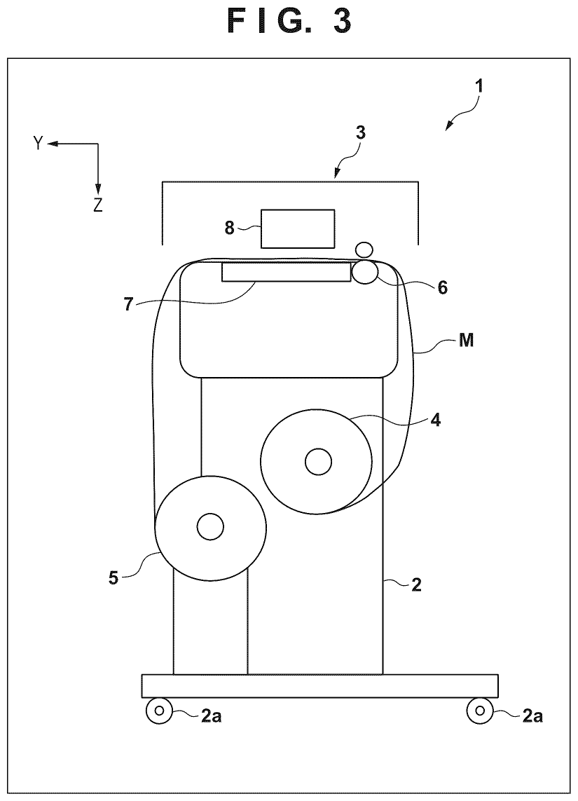

The liquid discharge apparatus 1 will now be described with reference to FIGS. 1 and 2 as well as FIG. 3. FIG. 3 is an explanatory diagram of the internal structure of the liquid discharge apparatus 1. The liquid discharge apparatus 1 includes a left and right pair of stands 2 and a body 3 supported on the pair of stands 2. Each stand 2 is provided with a caster 2a that allows the liquid discharge apparatus 1 to be relatively easily moved on the floor. Beneath the body 3, a feeding unit 4, a drying unit 14, and a winding unit 5 are disposed. According to the present embodiment, a printing medium M is a paper roll, and the feeding unit 4 includes a shaft that the printing medium M is wound on. The winding unit 5 includes a shaft that the printing medium M is wound on. In the present embodiment, the printing medium M is a paper roll, but cut paper may be used.

The body 3 is provided with a conveyance unit 6. The conveyance unit 6 includes a driving roller and the driven roller, and the printing medium M fed from the feeding unit 4 is sandwiched by the nip portions of the rollers. The printing medium M is conveyed on to a platen 7 by the rotation of the driving roller. A discharge head 8 is disposed facing the platen 7. The discharge head 8 is a print head that forms images by discharging ink. An image is printed on the printing medium M by ink being discharged by the discharge head 8 onto the printing medium M conveyed onto the platen 7.

The discharge head 8 includes a discharge energy generating element such as an electrothermal conversion element (heater) or a piezo element, for example, and discharges ink from a discharge port. In the case of using an electrothermal conversion element, bubbles are produced in the ink by the generation of heat, and the bubble forming energy can be used to discharge the ink from the discharge port. The printing method of the discharge head 8 may be a serial scan method or may be a full line method. In the case of a serial scan method, the discharge head 8 is installed in a carriage and moved back and forth in the X direction. The discharge head 8 discharging ink while moving in the X direction is referred to as a print scan. The conveying action of the printing medium M and the print scanning of the discharge head 8 are alternately repeated to print an image on the printing medium M. In the present embodiment, it is assumed that the serial scan method is used. In the case of a full line method, the discharge head 8 elongated in the X direction is used to print an image while the printing medium M is being continuously conveyed.

The printing medium M with a printed image is passed through the drying unit 14 before being wound up at the winding unit 5. The drying unit 14 decreases the liquid component contained in the ink applied to the printing medium M by the discharge head 8 and increases the fixability of the ink to the printing medium M. The drying unit 14 has a blowing mechanism such as a heater or other heat source, a fan, and the like and drys the printing medium M by sending hot wind at the printing medium M passing through at least from the ink applying surface side. Note that the drying method may not be a method of sending hot wind and may be a combination of a method of irradiating the printing medium M surface with electromagnetic waves (ultraviolet, infrared, or the like) and a thermal conduction method using contact with a heating element. Also, the drying unit 14 may be configured to only blow and not include a heat source. The printing medium M with a printed image is cut by the user using scissors or the like or is automatically cut with a cutter (not illustrated).

A recovery unit 9 is disposed in the body 3. The recovery unit 9 is disposed outside of the printing region of the discharge head 8 (outside of the discharge region) and executes processing relating to the recovery and maintaining the discharge performance of the discharge head 8. Examples of such processing includes, for example, preliminary discharge in which a predetermined amount of ink is discharged before the printing operation and processing of suctioning up remaining ink or the like from the discharge port of the discharge head 8. The discharge head 8 is moved on the recovery unit 9 when recovery processing is required as illustrated in FIG. 2.

A control panel 10 is provided on the front surface of the body 3. Also, the control panel 10 is a touch panel, for example, and can receive the input of various types of settings relating to printing, display the print job status, and the like. The liquid discharge apparatus 1 is also provided with a waste liquid cartridge 11. The waste liquid cartridge 11 is disposed under one end portion of the body 3 on the opposite side to the liquid storage apparatuses 20A and 20B in the X direction.

Waste liquid (waste ink and the like) suctioned up by the recovery unit 9 flow and collects at the waste liquid cartridge 11. The waste liquid cartridge 11 may be disposed near the recovery unit 9. However, according to the present embodiment, the installation area of the liquid discharge apparatus 1 is reduced by the waste liquid cartridge 11 being disposed in the free space under one end portion of the body 3.

### Liquid Storage Apparatus

FIGS. 1 and 2 will now be referenced. The liquid storage apparatuses 20A and 20B are apparatuses that store a liquid such as ink to be discharged from the discharge head 8 and supply a liquid such as ink to the liquid discharge apparatus 1. The liquid storage apparatuses 20A and 20B includes a box-shaped body 22 forming a plurality of storage portions 23A and a single storage portion 23B. The bottom surface of the body 22 is provided with casters 22a that allow the liquid storage apparatuses 20A and 20B to be relatively easily moved on the floor.

The liquid storage apparatuses 20A and 20B includes the plurality of storage portions 23A arranged in the Z direction. Each storage portion 23A has the form of a slot opening to a front wall portion 22b of the body 22. Each storage portion 23A can be detachably inserted with a container support unit 24 in the Y direction. The container support unit 24 supports a liquid storage container 200 (also simply referred to as a storage container 200) described below in a manner allowing it to be replaced.

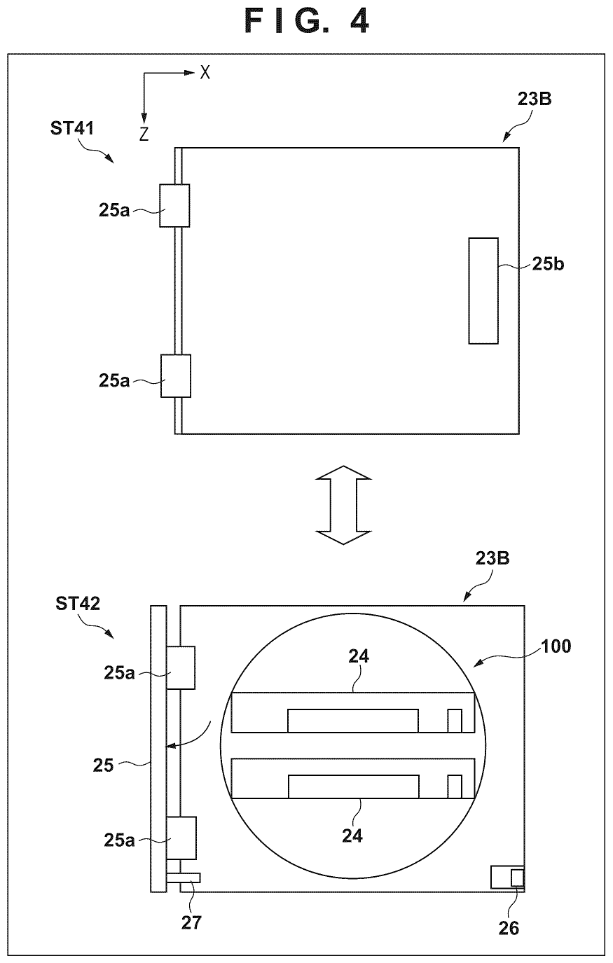

The liquid storage apparatus 20A includes the storage portion 23B. The storage portion 23B includes a space larger than the storage portion 23A opening to the front wall portion 22b of the body 22 and is opened and closed by an opening and closing member 25 provided on the front wall portion 22b. FIG. 4 is a front view of the storage portion 23B, with a state ST41 illustrating the opening and closing member 25 is a closed state and a state ST42 illustrating the opening and closing member 25 in an open state.

The opening and closing member 25 is a door supported on the front wall portion 22b via a plurality of hinges 25a at one end portion in the X direction, and a handle 25b that can be gripped by a user is provided at the other end in the X direction. When the handle 25b is pulled by the user in the state of the state ST41, as illustrated in the state ST42, the opening and closing member 25 rotates about the hinges 25a and exposes the inside of the storage portion 23B. Note that in the present embodiment, the opening and closing member 25 has a rotating mechanism, but a sliding mechanism may be used.

The body 22 is provided with a sensor 26 that detects the open/closed state of the opening and closing member 25. The sensor 26 detects a detection piece 27 provided on the opening and closing member 25. The sensor 26 is an optical sensor, for example, and is disposed so that the detection piece 27 is detected when the opening and closing member 25 is in the closed state and the detection piece 27 is not detected when the opening and closing member 25 is in the open state.

The storage portion 23B includes a built-in liquid stirring apparatus (stirring portion) 100. The liquid stirring apparatus 100 can be detachably inserted with the plurality of container support units 24 in the Y direction. In the present embodiment, two container support units 24 can be mounted in the liquid stirring apparatus 100. The liquid stirring apparatus 100 has the function of stirring the liquid inside the storage container 200 supported in the container support unit 24. The liquid stirring apparatus 100 will be described below in detail. Note that in the present embodiment, the storage portions 23A and the storage portion 23B use the same container support unit 24, but they may use different container support units.

Each of the storage portions 23A and 23B are provided with a tube that connects the storage container 200 and the liquid discharge apparatus 1. Each tube passes through the inside of a single hose 21 that houses all of the tubes and is connected to the liquid discharge apparatus 1. The ink of the storage container 200 is supplied to the discharge head 8 via the tube.

The system A according to the present embodiment is provided with the two liquid storage apparatuses 20A and 20B. Thus, many types of ink can be used. In a case where the number of ink colors is increased to increase image quality or the number of the same ink colors is increased to improve productivity, providing the plurality of liquid storage apparatuses 20A and 20B in this manner is advantageous.

### Liquid Storage Container and Container Support Unit

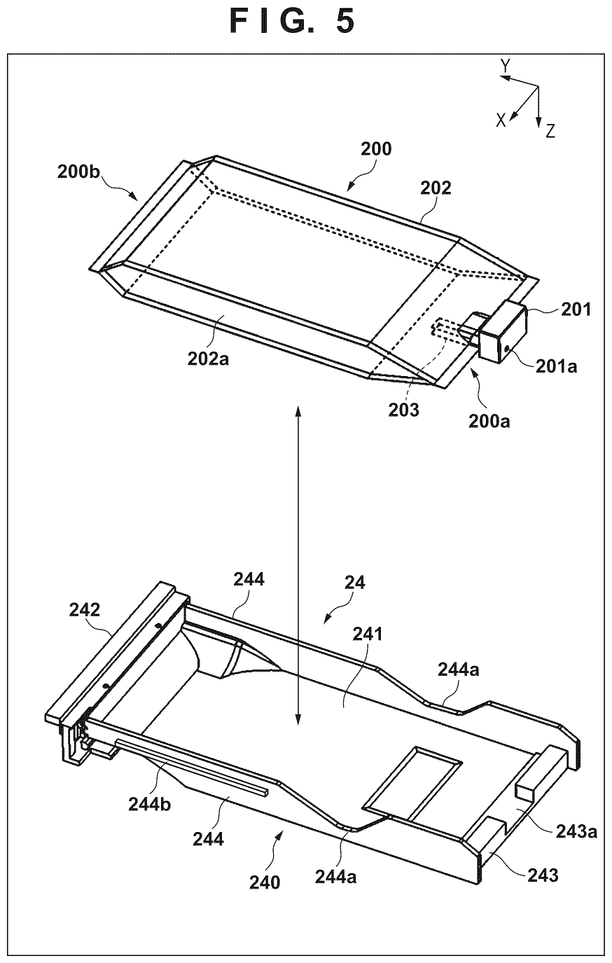

FIG. 5 is a perspective view of the storage container 200 and the container support unit 24. The storage container 200 includes a bag 202 formed of a flexible material. To increase the liquid storage capacity, both side surfaces of the bag 202 are provided with a gusset portion 202a where it folds in on itself. The bag 202 forms a flexible tank for storing liquid and is formed by welding together the sheets forming the top and bottom surface and a sheet forming the gusset portion 202a. When a large amount of liquid remains inside, the gusset portion 202a expands, and when a small amount of liquid remains inside, the gusset portion 202a folds in, allowing the shape of the bag 202 to change according to the amount of liquid in storage. The material of the bag 202 is a material configured with a plurality of layers such as PET, for example. In a case where there is a possibility of the liquid inside reacting with air and solidifying or the concentration or remaining amount changing due to evaporation, it is advantageous to use a layer material including an aluminum layer as the material of the bag 202.

The storage container 200 includes a first end portion 200a and a second end portion 200b in the long side direction. In a state where the storage container 200 is mounted in the liquid storage apparatuses 20A and 20B, the end portion 200a is located at the back side of the liquid storage apparatuses 20A and 20B, and the end portion 200b is located at the front side. The end portion 200a is provided with an outlet member 201. The outlet member 201 is formed of supply port 201a connected to an intake 203 inside the bag 202. The liquid stored in the bag 202 flows out via the intake 203 and the supply port 201a. Inside the outlet member 201, a spring-loaded supply port open/close valve that opens and closes the supply port 201a is provided. The supply port 201a is normally maintained in a closed state by the supply port open/close valve.

The storage container 200 has a length on the side where the outlet member 201 is provided of approximately 180 mm, and the length on the side (side surface) perpendicular to this is approximately 400 mm, for example. Approximately 1.5 L of liquid can be stored in the storage container 200, for example. Note that the side where the outlet member 201 is may be the long side and not the short side. Also, the bag 202 may have a square side in a plan view and not a rectangular shape.

The container support unit 24 includes a support portion 240 that supports the storage container 200 and has an overall shape of a tray that the storage container 200 rests in. The support portion 240 includes a placement surface 241 where the storage container 200 is placed, and the four side of the placement surface 241 are defined by left and right side plates 244, a front end portion 242, and a back end portion 243. A cutout portion 244a is formed in the side plates 244. A recess portion 243a where the outlet member 201 is disposed is formed in the back end portion 243. A rib 244b running in the Y direction is provided on the side plates 244.

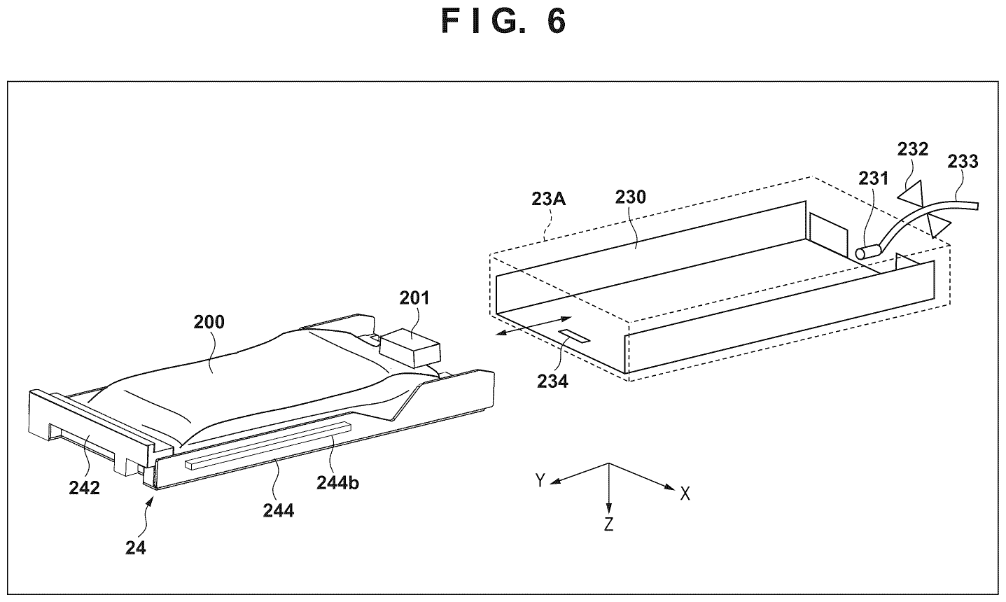

FIG. 6 will be referenced. FIG. 6 is an explanatory diagram illustrating how the container support unit 24 is mounted in the storage portion 23A. Note that here, how the container support unit 24 is mounted in the storage portion 23A will be described. However, how the container support unit 24 is mounted in the liquid stirring apparatus 100 of the storage portion 23B is essentially the same.

The storage portion 23A is provided with a case 230 that receives the container support unit 24. The container support unit 24 can move in the Y direction between a stored position where the storage container 200 is stored in the body 22 and a removed position where the storage container 200 is exposed outside the body 22. In FIG. 6, the container support unit 24 is located at the removed position. At the removed position, the storage container 200 can be replaced. At the stored position, the storage container 200 is mounted in the case 230.

Note that in the present embodiment, the container support unit 24 is separated from the storage portion 23A at the removed position. However, the removed position may be a position where the end portion of the container support unit 24 is held inside the storage portion 23A, and it is sufficient that the removed position is a position where the storage container 200 in the container support unit 24 can be replaced.

A needle member 231 configured to be inserted into the supply port 201a is provided at the back side of the case 230 in the Y direction. The needle member 231 is provided in each storage portion 23A. When the container support unit 24 is located at the stored position, the needle member 231 is inserted into the supply port 201a and is put in a connected state. Accordingly, the supply port open/close valve inside the outlet member 201 is put in an open state by the needle member 231 being inserted. The needle member 231 is connected to a tube 233. The needle member 231 and the tube 233 form a flow path for the liquid stored in the bag 202 to flow to the liquid discharge apparatus 1, which is the supply destination. A motorized flow path valve 232 is provided at an intermediate section of the tube 233. The tube 233 can be closed and opened by opening and closing the flow path valve 232.

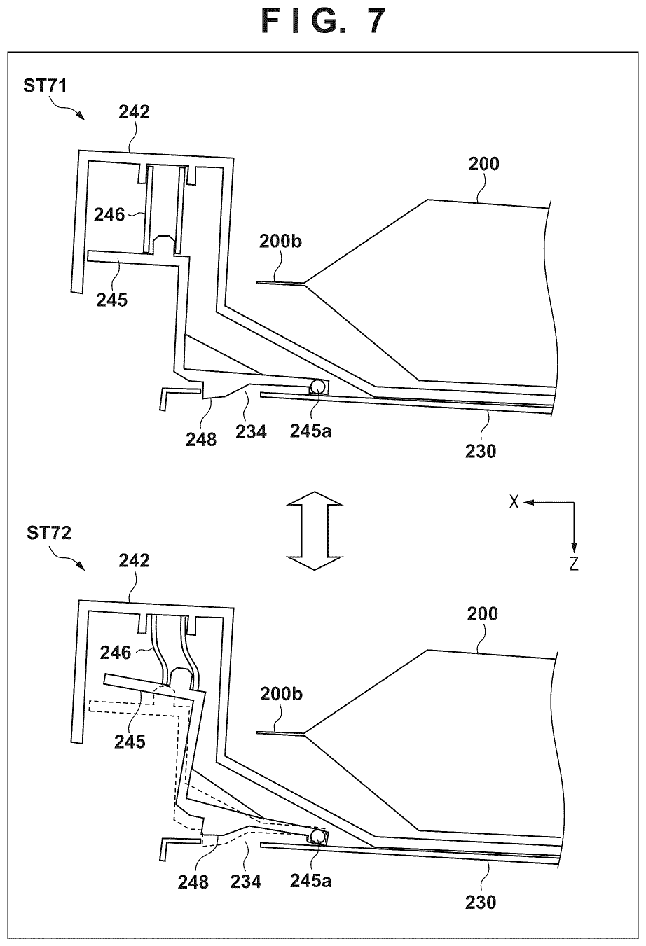

The mechanism of holding the container support unit 24 at the stored position will now be described with reference to FIG. 7. FIG. 7 is an explanatory diagram of the operation of a handle provided on the container support unit 24. In FIG. 7, a state ST71 is a held state, and a state ST72 is a hold-released state.

The front end portion 242 of the container support unit 24 is provided with a handle 245 that freely rotates about a shaft 245a extending in the X direction. The handle 245 can be operated by a user. The handle 245 also functions as an operation handle of an engagement portion 248. The handle 245 is provided with the engagement portion 248, and the bottom portion of the case 230 is provided with an engagement portion 234 configured to engage with the engagement portion 248.

According to the present embodiment, the engagement portion 248 is a protrusion portion, and the engagement portion 234 is a recess portion or a hole portion that the engagement portion 248 is inserted into. When the engagement portion 248 and the engagement portion 234 are engaged, the container support unit 24 is prevented from falling out from the storage portion 23A even when vibrations are caused by movement of the liquid storage apparatus 20A or the like, for example.

The handle 245 is normally biased toward the engagement position (position of the state ST71 in FIG. 7) side where the engagement portion 248 and the engagement portion 234 are engaged by an elastic member 246. The elastic member 246 is a coil spring, for example. When the user grips the handle 245 and turns the handle 245, the engagement between the engagement portion 248 and the engagement portion 234 is released as illustrated in the state ST72, and the container support unit 24 inserted into the storage portion 23A can be removed from the storage portion 23A.

### Liquid Stirring Apparatus

Various types of liquid can be stored in the storage container 200 and used in the printing of images, the maintenance of the discharge head 8, and the like. Depending on the type of ink, the color material (pigment component or the like) in the ink can settle out of the ink as time passes. For example, a pigment component of pigment ink with high water resistance and light resistance or a titanium oxide component used in white color do not dissolve in water. Thus, if left for a long time, they settle down to the container bottom portion due to gravity and undergo deposition and agglomeration. Thus, to obtain the required color development, the color developing component in the liquid needs to be evenly dispersed while a predetermined particle size is maintained. In the present embodiment, by providing the liquid stirring apparatus 100, the liquid can be stirred and the particles dispersed in this manner, allowing the uniformity to be improved. In particular, via the automation of liquid stirring, the burden on the user can be reduced.

### Apparatus Overview

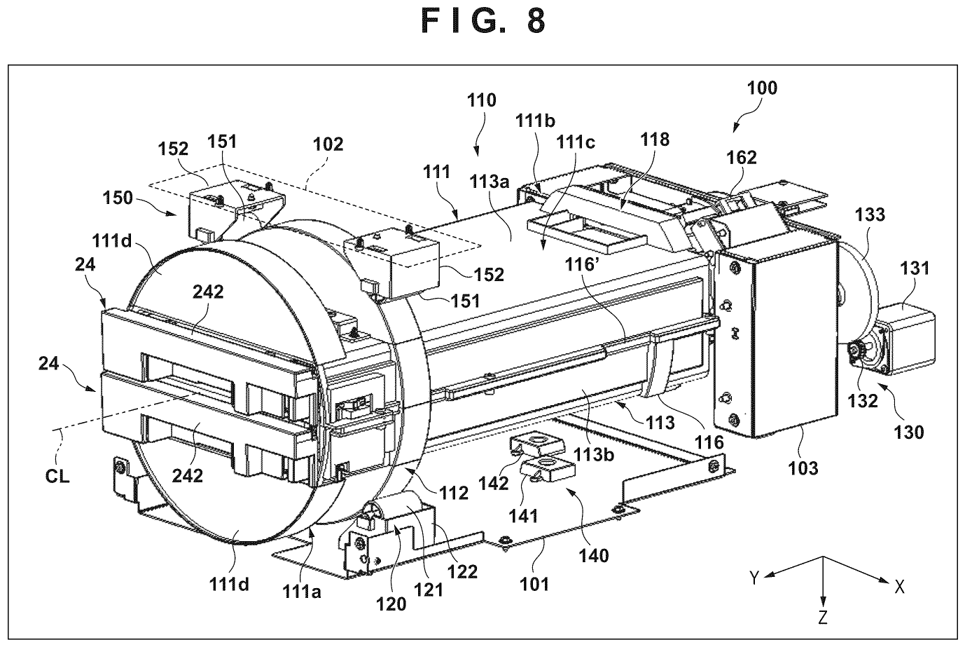

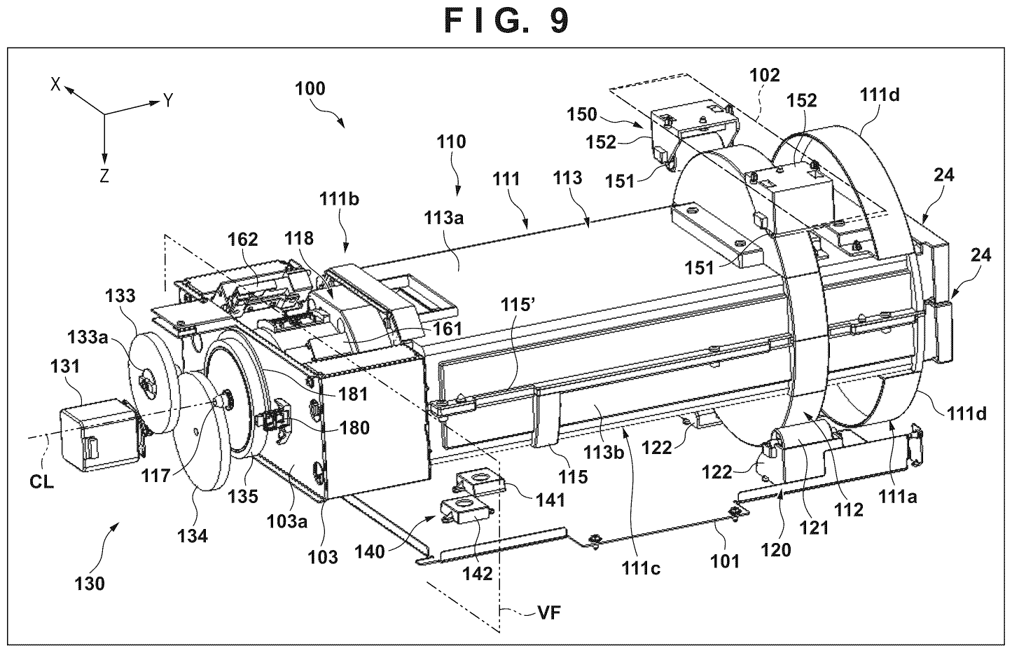

FIGS. 8 and 9 are perspective views of the liquid stirring apparatus 100. FIG. 8 is a perspective view of the liquid stirring apparatus 100 from the front side. FIG. 9 is a perspective view of the liquid stirring apparatus 100 from the back side.

The liquid stirring apparatus 100 includes a storage unit 110 that stores liquid, a support unit 120 that supports the storage unit 110 allowing for free rotation, and a drive unit 130 that rotates the storage unit 110 supported by the support unit 120. These configurations are supported on the body 22 of the liquid storage apparatus 20A by a frame including frames 101 to 103.

In the present embodiment, the liquid stored in the storage unit 110 is stirred by the storage unit 110 being rotated about a rotation center line CL indicated as an imaginary line. By the storage unit 110 being rotated, the liquid can be more effectively stirred. The rotation center line CL is a line that passes through the storage unit 110, and the direction is the Y direction in the present embodiment.

According to the present embodiment, two container support units 24 are configured to be freely insertable or removable in/from the storage unit 110 from the front side of the storage unit 110. Accordingly, the liquid inside the two storage containers 200 can be simultaneously stirred. The two container support units 24 are mounted on the storage unit 110 in two levels overlapping in the vertical direction. Note that the number of container support units 24 that can be mounted may be three or more or may be one.

The drive unit 130 is disposed at the back side of the storage unit 110, ensuring that there is a relatively wide space at the front side of the storage unit 110. Accordingly, the accessibility for the user relating to inserting and removing of the container support unit 24 with respect to the storage unit 110 is improved. Also, since the liquid stirring apparatus 100 has an overall structure that extends in the Y direction, the liquid stirring apparatus 100 can have a smaller size in the X direction.

### Storage Unit

FIGS. 8 and 9 will now be referenced. The storage unit 110 includes a storage member 111 that extends in the direction of the rotation center line CL and a shaft fixing member 118.

The storage member 111 is a hollow member that stores the storage container 200. The storage member 111 includes a front end portion 111a corresponding to one end portion in the direction (Y direction) of the rotation center line CL and a back end portion 111b corresponding to the other end portion. Between the front end portion 111a and the back end portion 111b, an outer wall portion 111c of the storage member 111 is formed by a cylindrical portion 112 and a rectangular tube portion 113. The cylindrical portion 112 is formed closer to the front end portion 111a than the back end portion 111b, and the rectangular tube portion 113 is formed, from the cylindrical portion 112, at the front end portion 111a side and the back end portion 111b side. The cylindrical portion 112 forms the outer circumferential surface of the cylinder shape. The rectangular tube portion 113 essentially has a rectangular prism-like shape. When the liquid stirring apparatus 100 is viewed in a front view, a cover member 111d with a sector shape covering the configuration behind the front end portion 111a is attached to the front end portion 111a.

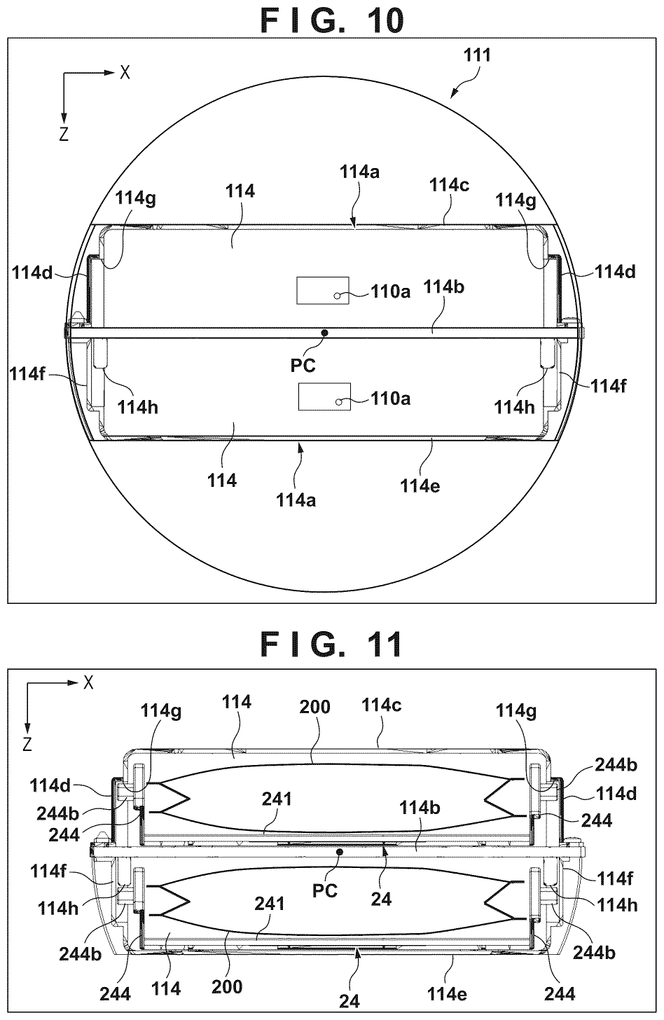

FIGS. 10 and 11 will now be referenced in addition to FIGS. 8 and 9. FIG. 10 is a front view of an upper and lower storage space 114 formed by the storage member 111 in a state with the container support unit 24 removed from the storage space 114. FIG. 11 is also a front view of the upper and lower storage space 114 illustrating in particular the appearance (cross-sectional shape) when the container support unit 24 is stored in the storage space 114. The storage space 114 is formed across the entire region of the cylindrical portion 112 and the rectangular tube portion 113. Note that unless matters relating to direction are specifically mentioned in the follow description, it is assumed that the storage unit 110 is at an initial position.

The internal space of the storage member 111 is partitioned into two levels, an upper and a lower level, by a partition wall 114b extending in the X-Y direction, and the storage space 114 along the rotation center line CL is formed both above and below the partition wall 114b. At the front end portion 111a of the storage member 111, an opening portion 114a serving as the entrance to the storage space 114 opens.

The container support unit 24 can move in the Y direction between a stored position where the storage container 200 is stored in the storage space 114 and a removed position where the storage container 200 is exposed outside the storage unit 110. At the removed position, the storage container 200 can be replaced. Since the storage container 200 can be replaced, a liquid replenishment task can be quickly performed and the container support unit 24 can be repeatedly used. Also, according to the present embodiment, there are few structures near the opening portion 114a that would impede replacement work, increasing the performance of the storage container 200 replacement work.

Note that in the present embodiment, the container support unit 24 is separated from the storage space 114 at the removed position. However, the removed position may be a position where the end portion of the container support unit 24 is held inside the storage space 114, and it is sufficient that the removed position is a position where the storage container 200 in the container support unit 24 can be replaced.

The back side of the storage space 114 (on the end portion 111b side of the storage member 111) is closed off, and a needle member 110a projects from the wall portion in the Y direction. The needle member 110a is inserted into the supply port 201a of the container support unit 24 when the container support unit 24 is inserted into the storage space 114. When the needle member 110a is inserted into the supply port 201a, a flow path is formed for the liquid stored in the bag 202 supported by the container support unit 24 to flow to the liquid discharge apparatus 1, which is the supply destination.

The storage space 114 according to the present embodiment is a space shaped like a flat rectangular parallelepiped extending in the Y direction, with the height in the Z direction being less than the width in the X direction. Note that the storage space 114 may be a space shaped like a flat rectangular parallelepiped extending in the Y direction, with the height in the Z direction being greater than the width in the X direction.

The storage space 114 on the upper side is defined by a top wall 114c, left and right side walls 114d, and the partition wall 114b serving as the bottom wall. The storage space 114 on the lower side is defined by a bottom wall 114e, left and right side walls 114f, and the partition wall 114b serving as the top wall. The partition wall 114b serving as the bottom wall of the storage space 114 on the upper side and the bottom wall 114e of the storage space 114 on the lower side can be provided with an engagement portion corresponding to the engagement portion 234 that holds the container support unit 24 in the stored position as described with reference to FIG. 7.

A guide portion 114g is formed on each of the left and right side walls 114d of the storage space 114 on the upper side. The guide portion 114g has a shoulder-like cross-sectional shape with a step or an incline and extends in the Y direction. When the container support unit 24 is inserted or removed into/from the storage space 114, the guide portion 114g functions as a rail that the rib 244b of the container support unit 24 slides against to guide the movement of the container support unit 24 in the inserting or removing direction. Also, the guide portion 114g comes into contact with the rib 244b in a direction intersecting the direction of the rotation center line CL (the Z direction at the initial position), and the container support unit 24 is restricted in movement in this intersecting direction. This can reduce or prevent the container support unit 24 from rattling inside the storage space 114 when the storage unit 110 is rotated.

In a similar manner, a guide portion 114h is formed on each of the left and right side walls 114f of the storage space 114 on the lower side. The guide portion 114h has a protrusion shape projecting downward from the partition wall 114b and extending in the Y direction. When the container support unit 24 is inserted or removed into/from the storage space 114, the guide portion 114h functions as a rail that the rib 244b of the container support unit 24 slides against to guide the movement of the container support unit 24 in the inserting or removing direction. Also, the guide portion 114h comes into contact with the rib 244b in a direction intersecting the direction of the rotation center line CL (the Z direction at the initial position), and the container support unit 24 is restricted in movement in this intersecting direction. This can reduce or prevent the container support unit 24 from rattling inside the storage space 114 when the storage unit 110 is rotated.

A rotation center PC of the storage unit 110 is located on the partition wall 114b. The rotation center PC is a discretionary point on the rotation center line CL. According to the configuration of the present embodiment, the rotation center line CL passes between the two storage space 114. Thus, the liquid inside the two storage containers 200 can be uniformly stirred by the storage unit 110.

### Rotation Support Structure

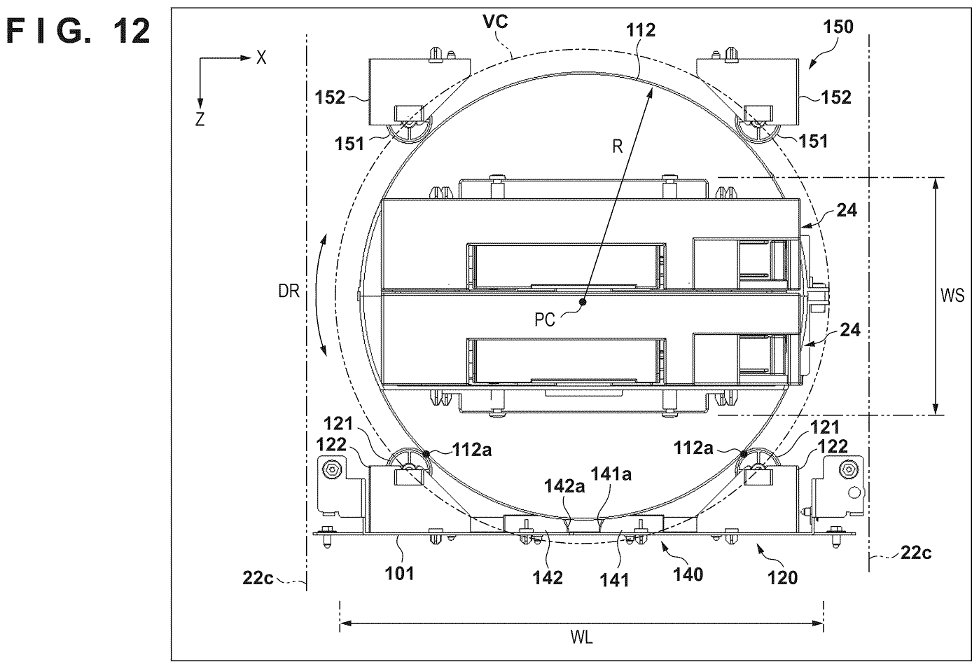

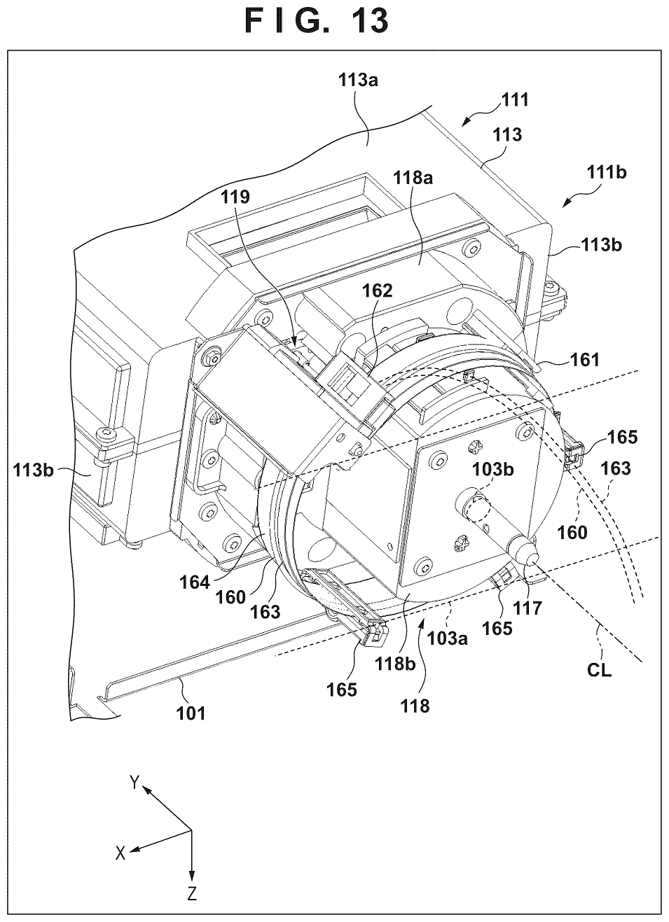

The structure supports the storage unit 110 in a manner allowing for free rotation will now be described with reference to FIGS. 8, 9, 12, and 13. FIG. 12 is a front view of the liquid stirring apparatus 100 mainly illustrating the rotation support structure of the storage unit 110. FIG. 13 is a perspective view illustrating the back portion of the storage unit 110 in a state with the drive unit 130 removed.

Issues relating to a structure that supports the storage unit 110 in a manner allowing for free rotation will now be described. If a shaft is provided in the storage unit 110 at both end portions on the rotation center line CL, due to the presence of a shaft and bearing, the flexibility in design may be reduced and the user-friendliness for the user may be reduced. For example, as in the present embodiment, in a structure in which the container support unit 24 is inserted or removed into/from the storage unit 110, there may be restrictions on the inserting or removing site or direction. Also, with a structure that stores and stirs a large amount of liquid, it may be necessary to strengthen the rigidity of the shaft and bearing taking into account the weight of the liquid.

In the present embodiment, by combining the support unit 120, which is a shaft-less support structure and a support structure with a shaft (a shaft member 117 and bearing member 103a described below), such issues are resolved.

The support unit 120 is a mechanism that comes into contact with the outer wall portion 111c of the storage unit 110 and supports the storage unit 110 in a manner allowing for free rotation. The support unit 120 according to the present embodiment supports the storage unit 110 in a manner allowing for free rotation about the rotation center line CL by a plurality of contact portions 121 coming into contact with the cylindrical portion 112 of the storage member 111. According to the present embodiment, the support unit 120 is provided with two contact portions 121. These two contact portions 121 come into contact with the cylindrical portion 112 at contact positions 112a separated from the cylindrical portion 112 in the circumferential direction.

Each contact portion 121 according to the present embodiment is a roller supported by a bearing 122 to rotate about a shaft in a direction parallel with the rotation center line CL (Y direction). The bearings 122 are supported by the frame 101. The circumferential surface of each contact portion (roller) 121 comes into contact with the cylindrical portion 112, and the storage unit 110 is placed between the two contact portions (rollers) 121 and rotated freely in an arrow DR direction of FIG. 12 in this state. Since the storage unit 110 is supported from below by the two contact portions 121, even in a case where the storage unit 110 stores a large amount of liquid and the weight is great, structural stability is obtained without requiring significant rigidity reinforcement.

The cylindrical portion 112 is formed closer to the side of the front end portion 111a than the side of the back end portion 111b of the storage member 111, and the support unit 120 supports the storage unit 110 in a manner allowing for free rotation at a position closer to the side of the front end portion 111a than the side of the back end portion 111b. The storage unit 110 is supported by the shaft-less support unit 120 near the opening portion 114a serving as the entrance where the container support unit 24 is inserted or removed into/from the storage space 114. Since there are no shafts or bearings in front of the liquid stirring apparatus 100, the user-friendliness for the user relating to the task of inserting or removing the container support unit 24 can be improved. Also, in some cases, the load in the gravity direction may act near the opening portion 114a due to the task of inserting or removing the container support unit 24. However, since the two contact portions 121 are supporting the storage unit 110 from below near the opening portion 114a, this load can be stably received.

Also, the storage member 111 has a structure including the cylindrical portion 112 and the rectangular tube portion 113. Thus, compared to it being formed overall with the cylindrical portion 112, the weight can be reduced and the rotational inertia moment can be reduced. The rectangular tube portion 113 includes a long side portion 113a and a short side portion 113b forming the contour of the rectangle. According to the present embodiment, a width WL of the long side portion 113a, a width WS of the short side portion 113b, and a radius R of the cylindrical portion 112 have the relationship: WL>WS, WS<2×R. By making the width WS of the rectangular tube portion 113 less than the diameter (2×R) of the cylindrical portion 112, the weight can be reduced and the rotational inertia moment can be reduced.

On the other hand, due to the relationship WL>2×RR, the cylindrical portion 112 and the contact position 112a are located inside of an imaginary circle VC centered on the rotation center PC that runs through the outermost portion of the storage unit 110. This can reduce the size of the liquid stirring apparatus 100. Since the side walls 22c of the storage portion 23B can be brought closer together due to the storage unit 110, the size of the liquid stirring apparatus 100 in the X direction can be reduced.

The shaft member 117 is provided at the back portion (back end portion 111b side) of the storage unit 110. The shaft member 117 is fixed to the end portion of the shaft fixing member 118 and extends along the rotation center line CL. The shaft fixing member 118 is a hollow body including a flange portion 118a fixed to the back end portion 111b of the storage member 111 and a barrel portion 118b extending backwards from the flange portion 118a. The shaft member 117 is fixed to the end portion of the barrel portion 118b. The frame 103 includes the plate-like bearing member 103a, and the shaft member 117 is inserted through a shaft hole 103b and supported. Since the storage unit 110 is supported in a manner allowing for free rotation by the shaft member 117 and the bearing member 103a and not only the support unit 120, misalignment of the rotation center PC of the storage unit 110 can be prevented and more stable rotation can be achieved. The shaft member 117 and the bearing member 103a are located on opposite side of the opening portion 114a from the storage unit 110. Thus, the user-friendliness for the user relating to the task of inserting or removing the container support unit 24 is not reduced.

The liquid stirring apparatus 100 also includes a restricting unit 150 that restricts the movement of the storage member 111 in a direction intersecting the rotation center line CL. The restricting unit 150 according to the present embodiment restricts the upward movement of the storage member 111 in the Z direction. When the container support unit 24 is inserted or removed, a force in the upward direction acts on the front side of the storage unit 110, inclining the orientation. This makes a load in the bend direction act on the shaft member 117. By providing the restricting unit 150, such a change in orientation can be prevented.

The restricting unit 150 according to the present embodiment includes a plurality of contact portions 151 facing the cylindrical portion 112 in the Z direction at positions higher than the rotation center line CL. If the storage member 111 is moved upward, the plurality of contact portions 151 come into contact with the cylindrical portion 112 to physically prevent the movement. The plurality of contact portions 151 may normally be in contact with the cylindrical portion 112 or may be normally located at positions slightly separated in the Z direction.

According to the present embodiment, the restricting unit 150 is provided with the two contact portions 151, and these two contact portions 151 are separated from one another in the circumferential direction of the cylindrical portion 112. Each contact portion 151 according to the present embodiment is a roller supported by a bearing 152 to rotate about a shaft in a direction parallel with the rotation center line CL (Y direction). The bearings 152 are supported by the frame 102.

The two contact portions 151 are located at the same positions in the X direction and the Y direction as the two contact portions 121 of the support unit 120. The set of the two contact portions 151 and the bearings 152 may use the same components as the two contact portions 121 and the bearings 122 of the support unit 120. By using the same components, the number of different types of components can be reduced.

### Drive Unit

The structure of the drive unit 130 will now be described with reference to FIGS. 8 and 9. The drive unit 130 is disposed to the outer side (back side) of the back end portion 111b of the storage member 111 in the direction of the rotation center line CL. By disposing the drive unit 130 on the opposite side of the opening portion 114a from the storage unit 110, the number of mechanisms near the opening portion 114a can be reduced. This can improve the user-friendliness for the user relating to the task of inserting or removing the container support unit 24.

The drive unit 130 includes a motor 131 as a drive source. The motor 131 is fixed to a frame (not illustrated). The output shaft of the motor 131 is installed with a gear 132. According to the present embodiment, the motor 131 is a step motor. The rotation amount of the storage unit 110 can be controlled by the rotation amount of the motor 131. The motor 131 may be a DC motor. In this case, since the rotation amount is controlled, a rotation amount sensor such as a rotary encoder may be provided.

The drive unit 130 includes gears 133, 134, and 135. The gears 133 and 134 are supported by a frame (not illustrated) in a manner allowing for free rotation. The gears 133 and 134 are each double gears, with the gear 132 and the larger gear of the gear 133 meshing, and the larger gear of the gear 134 and the smaller gear of the gear 133 meshing. Also, the gear 135 and the smaller gear of the gear 134 are in mesh. A torque limiter 133a is provided between the smaller gear and the larger gear of the gear 133 that can cutoff drive transmission of both. An excessive load acting on the motor 131 can be prevented by the torque limiter 133a. Also, in a case where the user erroneously touches the storage unit 110 while the storage unit 110 is rotating, the transfer of the driving force can be stopped by the torque limiter 133a to prevent a high load acting on the user's hand.

The gear 135 is fixed to the shaft member 117. When the motor 131 is driven, the driving force is transferred to the shaft member 117, making the storage unit 110 rotate. The bearing member 103a is located between the gear 135 and the shaft fixing member 118, and these position the bearing member 103a in the direction of the rotation center line CL of the storage unit 110. Note that in the present embodiment, a gear mechanism is used as the transmission mechanism for driving force from the motor 131 to the shaft member 117. However, a belt transmission mechanism or a similar transmission mechanism may be used.

### Example of Stirring Action

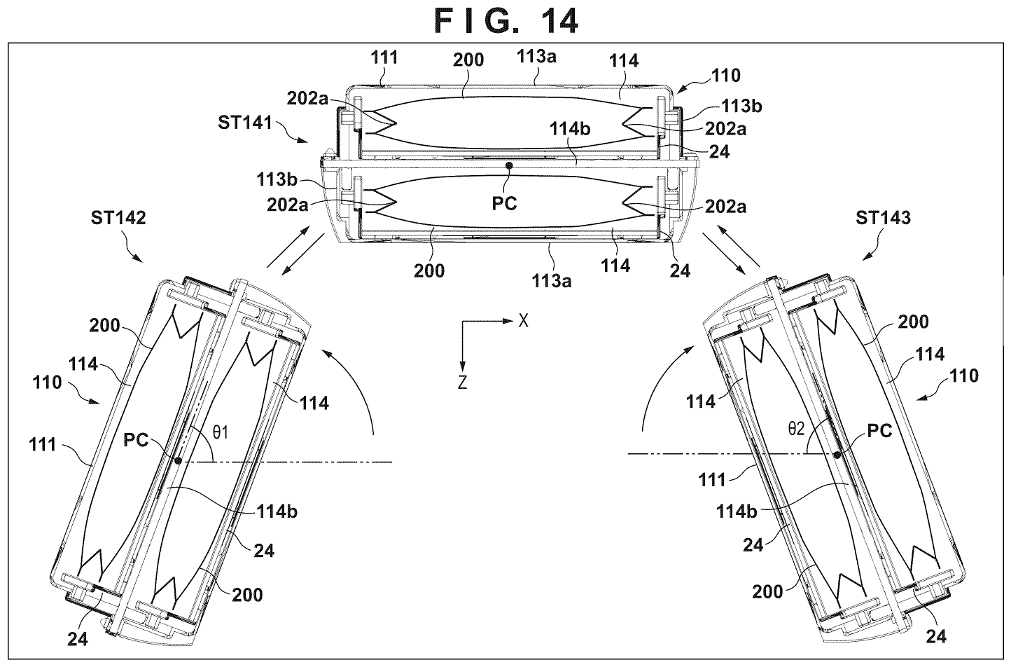

FIG. 14 illustrates an example of the stirring action (rotation action of the storage unit 110) via driving by the drive unit 130. A state ST141 illustrates a state in which the storage unit 110 is in an initial position. The storage member 111 in the initial position has a horizontal orientation with the long side portion 113a also lying horizontal. The support portion 240 and the storage container 200 of the container support unit 24 inside the storage space 114 also have a horizontal orientation, and the gusset portions 202a on both side surfaces of the storage container 200 are located at the same height.

A state ST142 indicates an inclined state in which the storage unit 110 is rotated from the initial position in the anticlockwise direction by an angle 01. The position of the storage unit 110 in this stage is referred to as the left-inclined position. Regarding the gusset portions 202a on both side surfaces of the storage container 200, the gusset portion 202a on the right side is located at a position higher than the gusset portion 202a on the left side in the same diagram. The liquid in the storage container 200 flows from the side of the gusset portion 202a on the right side to the side of the gusset portion 202a on the left side.

A state ST143 indicates an inclined state in which the storage unit 110 is rotated from the initial position in the clockwise direction by an angle θ2. The position of the storage unit 110 in this stage is referred to as the right-inclined position. Regarding the gusset portions 202a on both side surfaces of the storage container 200, the gusset portion 202a on the left side is located at a position higher than the gusset portion 202a on the right side in the same diagram. The liquid in the storage container 200 flows from the side of the gusset portion 202a on the left side to the side of the gusset portion 202a on the right side.

The orientation of the storage unit 110 repeatedly changes from the state ST141 to the state ST142 to the state ST141 to the state ST143 to the state ST141 and so on. This allows the liquid in the storage container 200 to be stirred.

When the orientation of the storage unit 110 changes from the state ST142 to the state ST143, the rotation may temporarily stop at the intermediate state ST141. On the other hand, the orientation of the storage unit 110 may continuously change from the state ST142 to the state ST143 without the rotation stopped at the intermediate state ST141. This also applies to a case where the orientation of the storage unit 110 changes from the state ST143 to the state ST142.

Alternatively, after the orientation of the storage unit 110 has continuously changed a plurality of times between the state ST142 and the state ST143 without stopping rotation at the intermediate state ST141, the rotation may stopped at a predetermined amount of time at the state ST141. Then, this action may be repeated. By stopping the rotation at a predetermined amount of time in the state ST141, the power consumption of the motor 131 can be reduced and the rotation can be resumed before the particles in the liquid settle allowing the uniformity of the liquid to be maintained.

The angle θ1 and the angle θ2 may be the same angle or may be different angles. The angle θ1 and the angle θ2 may be the same angle in a case where the stirring action is performed under a certain condition and may be different angles in a case where the stirring action is performed under a different condition. In a case where the angle θ1 and the angle θ2 are different angles, the size relationship between the two may switch between a case of θ1>θ2 and a case of θ1<θ2.

If the angle θ1 and the angle θ2 are too small, the stirring effect is reduced. If the angle θ1 and the angle θ2 are too large, the storage container 200 may twist. Accordingly, the angle θ1 and the angle θ2, for example, may be an angle selected from a range from 20 degrees to less than 90 degrees or may be an angle selected from a range from 60 degrees to 80 degrees. To give an example of a specific angle, 70 degrees may be used, for example.

The angle θ1 and the angle θ2 may be different angles depending on a starting condition of the stirring action. For example, under conditions where it is estimated that sedimentation has progressed, a large angle may be used. Under conditions where it is estimated that sedimentation has not progressed, a small angle may be used

The rotation control of the storage unit 110 includes accelerating from a static state, rotating at a constant speed, and decelerating and stopping. If the constant rotational speed (rotational speed of the motor 131) is too fast, the load on the storage container 200 may be excessive. If it is too slow, more time is needed for stirring. Thus, for example, the constant rotational speed may be a speed selected from a range from 20 deg/sec to 160 deg/sec or a speed selected from a range from 30 deg/sec to 140 deg/sec. A relationship may be set between the constant rotational speed and the angle θ1 and the angle θ2. For example, in a case where the angle θ1 and the angle θ2 are θα, the rotational speed may be V1, and in a case where the angle θ1 and the angle θ2 are θβ larger than θα, the rotational speed may be V2 which is slower than V1. This can achieve both a storage container 200 load reduction and liquid fluidity in a compatible manner.

### Rotation Range Restricting Structure

If the storage unit 110 rotates excessively, the drive system may failure or the flow of liquid may be inhibited by a twist in the tube that discharges the liquid. Excessive rotation may be caused by the user erroneously rotating the storage unit 110 by hand when inserting or removing the container support unit 24 into/from the storage unit 110, for example. The liquid stirring apparatus 100 according to the present embodiment is provided with a structure for physically restricting the rotation range of the storage unit 110.

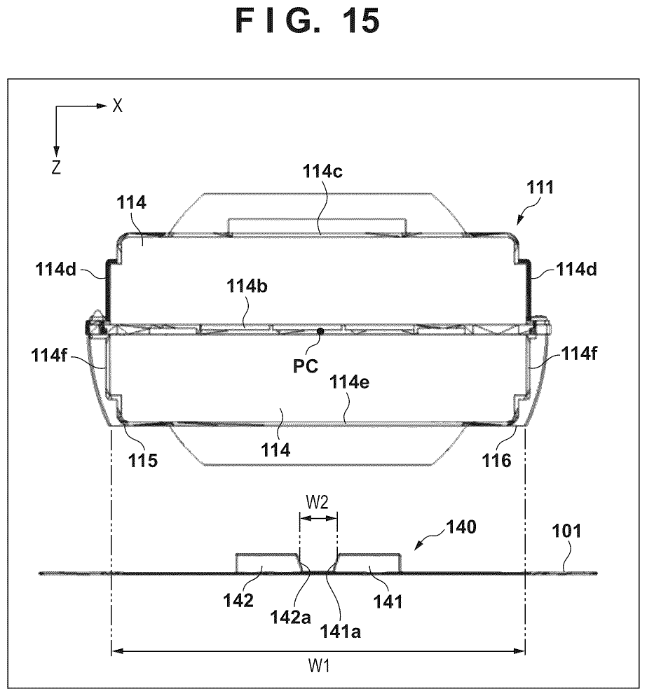

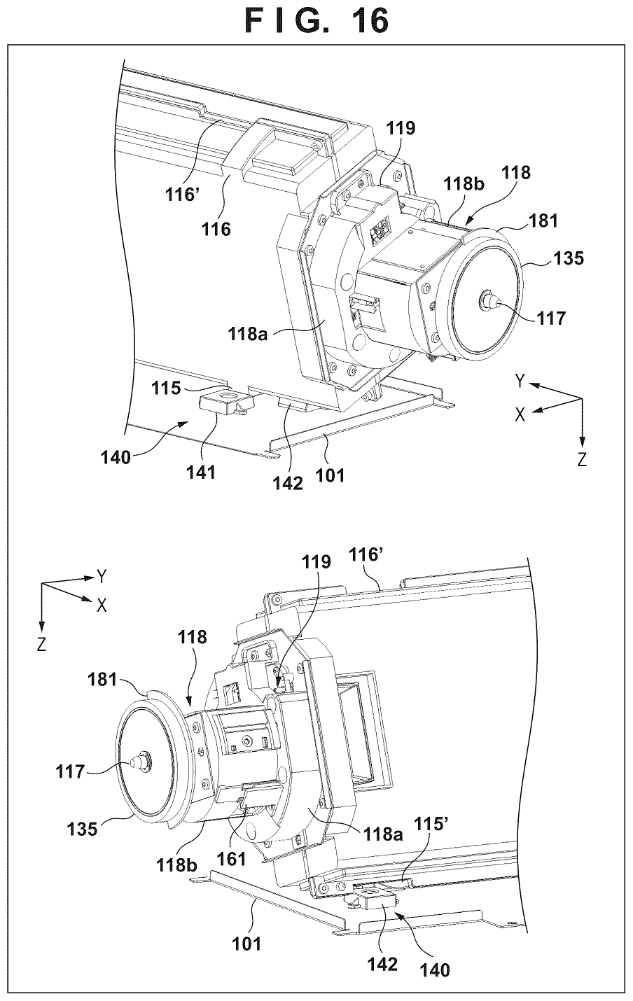

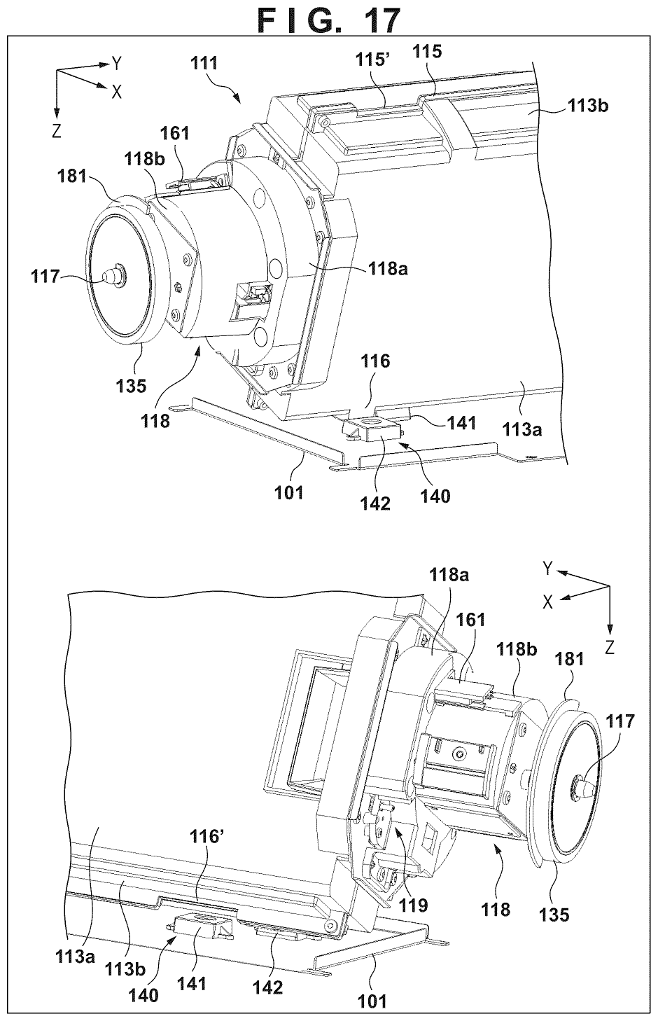

FIGS. 8, 9, 12, and 15 to 17 will now be referenced. FIG. 15 is an explanatory diagram of a rotation restricting unit 140, and FIGS. 16 to 17 are diagrams illustrating rotation restriction by the rotation restricting unit 140.

The liquid stirring apparatus 100 includes the rotation restricting unit 140 that restricts the rotation range of the storage unit 110. The rotation restricting unit 140 includes stoppers 141 and 142 that physically restrict rotation by coming into contact with the storage unit 110. By the stoppers 141 and 142 coming into contact with the storage unit 110 and directly restricting the rotation of the storage unit 110, excessive rotation of the storage unit 110 can be reliably prevented.

The stoppers 141 and 142 are block-like members fixed to the frame 101 and include inclined contact surfaces 141a and 142a. The stopper 141 restricts the upper limit of rotation in one direction (rotation from the state ST141 to the state ST142 in FIG. 14) of the storage unit 110 by coming into contact with a contact portion 115 formed on the outer wall portion 111c of the storage unit 110. The stopper 142 restricts the upper limit of rotation in the other direction (rotation from the state ST141 to the state ST143 in FIG. 14) of the storage unit 110 by coming into contact with a contact portion 116 formed on the outer wall portion 111c of the storage unit 110. According to the present embodiment, the angles of the upper limit of the rotation range restricted by the stoppers 141 and 142 are the same.

The contact portions 115 and 116 are formed on the rectangular tube portion 113 and in particular are formed on the long side portion 113a as opposed to the short side portion 113b. If a configuration is used in which the contact portions project out from the short side portions 113b, this presence tends to increase the diameter of the imaginary circle VC illustrated in FIG. 12. This may lead to an increase in the size of the liquid stirring apparatus 100 in the X direction and the Z direction. By forming the contact portions 115 and 116 on a portion of the long side portion 113a, the size of the liquid stirring apparatus 100 can be reduced.

As illustrated in FIG. 12, the contact surfaces 141a and 142a of the stoppers 141 and 142 are located on the inner side of the imaginary circle VC. In other words, each contact position between the stoppers 141 and 142 and the contact portions 115 and 116 in the radial direction (radial direction of the imaginary circle VC) of the rotation of the storage unit 110 is located on the inner side of the imaginary circle VC. The positions of the stoppers 141 and 142 in the X direction and the Z direction are kept in a small area, allowing the size of the liquid stirring apparatus 100 in the X direction and the Z direction to be reduced.

As illustrated in FIG. 15, when viewed from the direction of the rotation center line CL and based on the contact positions, the contact portion 115 and the contact portion 116 are separated by a distance W1 in the X direction, and the stopper 141 and the stopper 142 are separated by a distance W2 in the X direction. The relationship W1>W2 is true. The installation range in the X direction of the stopper 141 and the stopper 142 is kept within the width of the storage member 111, allowing the size of the liquid stirring apparatus 100 in the X direction to be reduced.

Also, the contact portions 115 and 116 are formed on the end portions (boundary with the short side portions 113b) in the X direction of the long side portions 113a. Since the stoppers 141 and 142 are located relatively far from the rotation center PC, even with relatively low rigidity, the stoppers 141 and 142 can more reliably restrict the rotation of the storage unit 110.

The stopper 141 and the stopper 142 are separated in the direction of the rotation center line CL (Y direction). In a manner corresponding to the stoppers 141 and 142, the contact portions 115 and 116 are separated in the direction of the rotation center line CL (Y direction). By disposing the stopper 141 and the stopper 142 offset in the direction of the rotation center line CL, even if the allowed range of the rotation of the storage unit 110 is great, the separation distance between the stopper 141 and the stopper 142 in the X direction can be made small. This can reduce the size of the liquid stirring apparatus 100 in the X direction.

FIG. 16 is a perspective view from two directions of how the rotation restriction on the storage unit 110 functions when the stopper 141 comes into contact with the contact portion 115. When the contact portion 115 comes into contact with the contact surface 141a of the stopper 141, any further rotation of the storage unit 110 is physically restricted. An interference avoidance portion 115′ is formed on the storage member 111 adjacent to the contact portion 115. According to the present embodiment, the interference avoidance portion 115′ is a recess portion for avoiding interference between the contact portion 116 and the storage member 111.

FIG. 17 is a perspective view from two directions of how the rotation restriction on the storage unit 110 functions when the stopper 142 comes into contact with the contact portion 116. When the contact portion 116 comes into contact with the contact surface 142a of the stopper 142, any further rotation of the storage unit 110 is physically restricted. An interference avoidance portion 116′ is formed on the storage member 111 adjacent to the contact portion 116. According to the present embodiment, the interference avoidance portion 116′ is a recess portion for avoiding interference between the contact portion 115 and the storage member 111.

Note that in the present embodiment, the rotation range of the storage unit 110 is restricted by contact between the stoppers 141 and 142 and the storage member 111. However, a different portion may be used to restrict the rotation range. For example, a stopper may come into contact with the gear 133, the gear 134, or the gear 135 of the drive unit 130 to restrict the rotation and thus restrict the rotation range of the storage unit 110.

### Rotation Position Detection

The storage unit 110 can be touched by the user, and the position of the storage unit 110 may be shifted when the power of the liquid stirring apparatus 100 is turned off. Also, according to the present embodiment, the drive transfer path of the drive unit 130 is provided with the torque limiter 133a. Thus, an error may occur between the rotation amount of the motor 131 and the rotation position of the storage unit 110. When the recognition error of the rotation position of the storage unit 110 is great, the rotation of the storage unit 110 may be unable to be controlled when the stirring action is performed. According to the present embodiment, by providing a sensor that detects the position of the storage unit 110, the recognition accuracy of the rotation position of the storage unit 110 is improved.

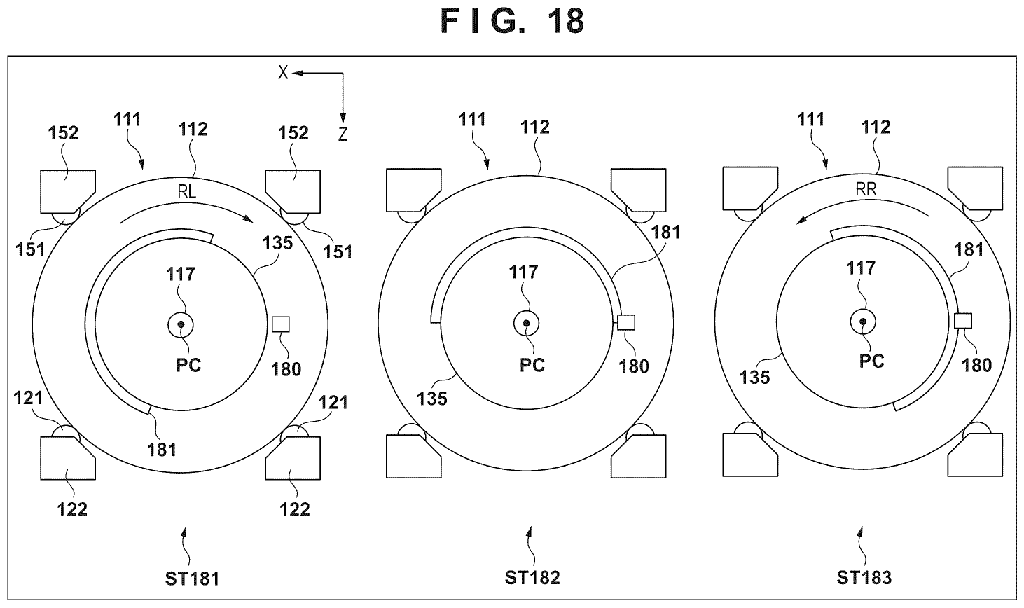

FIGS. 9, 16, 17, and 18 will now be referenced. FIG. 18 is an explanatory diagram of the storage unit 110 position detection operation.

The storage unit 110 is provided with a detection piece 181 that rotates about the rotation center line CL together with the storage unit 110. According to the present embodiment, the detection piece 181 is integrally formed with the gear 135 and is fixed to the shaft member 117 using the gear 135. A sensor 180 that detects the detection piece 181 is fixed to the frame 103. The sensor 180 is an optical sensor, for example, and detects whether or not the detection piece 181 is at the detection position of the sensor 180. When the storage unit 110 is viewed from the back side, the detection position is at 3 o'clock (see FIG. 18) if using an analogy of a clockface centered on the rotation center PC.

The detection piece 181 includes a portion that extends along the rotation center line CL, and in a case where the rotation position of the storage unit 110 is within a certain rotation range, the sensor 180 detects the detection piece 181. According to the present embodiment, the detection piece 181 has an arc shape (or a sector shape) centered on the rotation center line CL and in particular has a semicircular arc shape in the present embodiment.

According to the present embodiment, the position where the edge of the detection piece 181 crosses the sensor 180 (the detection result is a position changing from undetected to detected, for example) is set as the reference position. According to the present embodiment, the reference position corresponds to the initial position of the storage unit 110 (the state ST141 in FIG. 14). A state ST182 in FIG. 18 indicates the positional relationship between the detection piece 181 and the sensor 180 when the storage unit 110 is at the initial position.

The detection piece 181 is provided so that the detection piece 181 is detected by the sensor 180 while the storage unit 110 moves from the initial position to the left-inclined position illustrated by the state ST142 in FIG. 14. A state ST183 in FIG. 18 indicates an intermediate position of the rotation of the storage unit 110 from the initial position to the left-inclined position (the state ST142) in FIG. 14.

The detection piece 181 is provided so that the detection piece 181 is not detected by the sensor 180 while the storage unit 110 moves from the initial position to the right-inclined position illustrated by the state ST143 in FIG. 14. A state ST181 in FIG. 18 indicates an intermediate position of the rotation of the storage unit 110 from the initial position to the right-inclined position (the state ST143) in FIG. 14.

An example of processing using the detection result of the sensor 180 will now be described. The processing can be executed by a control unit 32 described below. First, an example of initialization processing to rotate the storage unit 110 to the initial position will be described with reference to FIG. 18. The initialization processing can be executed when the power of the liquid stirring apparatus 100 is turned on. Also, the initialization processing can be periodically executed after the power of the liquid stirring apparatus 100 is turned on, for example.

In the initialization processing, the detection result of the sensor 180 is first obtained and whether or not the detection piece 181 has been detected is determined. In a case such as that illustrated by the state ST181 in FIG. 18 where the detection piece 181 has not been detected, the storage unit 110 can be determined to be at a position rotated to the side of the right-inclined position (side of the state ST143 in FIG. 14) with respect to the initial position. Accordingly, the storage unit 110 is rotated in the direction of an arrow RL by the drive unit 130, and the rotation of the storage unit 110 is stopped at a position where the detection result of the sensor 180 changes from not detected to detected. The storage unit 110 is positioned at the initial position.

In a case such as that illustrated by the state ST183 in FIG. 18 where the detection piece 181 has been detected, the storage unit 110 can be determined to be at a position rotated to the side of the left-inclined position (side of the state ST142 in FIG. 14) with respect to the initial position. Accordingly, the storage unit 110 is rotated in the direction of an arrow RR by the drive unit 130. If the position where the detection result of the sensor 180 changes from detected to not detected is passed, the rotation direction of the storage unit 110 is reversed, and the storage unit 110 is stopped at a position where the detection result of the sensor 180 changes from not detected to detected. The storage unit 110 is positioned at the initial position.

In this manner, in the present embodiment, the shape of the detection piece 181 is a shape corresponding to the rotation position of the storage unit 110. Thus, in which rotation direction with respect to the initial position is the position can be determined by the detection result of the sensor 180. As a result, the initialization processing can be completed quickly.

Next, an example of rotation error processing of the storage unit 110 during the stirring action will be described. In the stirring action illustrated in FIG. 14, each time the storage unit 110 passes the initial position (the state ST141), the detection result of the sensor 180 switches from not detected to detected or from detected to not detected. In a case where the detection result of the sensor 180 does not change even if the rotation amount of the motor 131 reaches a predetermined amount, a foreign substance may interfere with the drive unit 130 or the storage unit 110 and cause a determination of cannot rotate.

In a case where cannot rotate is determined, as error processing, processing to stop the driving of the motor 131, notify the user, and the like can be executed. For example, a message may be displayed via the control panel 10 or a host computer 300 prompting the user to turn off the liquid discharge apparatus 1 or the liquid stirring apparatus 100 and perform initialization, the user may be notified of this message via audio, or the like. Alternatively, an error code may be displayed via the control panel 10 or the host computer 300 or the user may be notified of the same error code via audio, allowing the user to be guided to make a service call.

Note that in the present embodiment, the detection piece 181 is integrally formed with the gear 135. However, the position of the detection piece 181 is not limited to the gear 135. For example, the detection piece 181 may be provided on the storage member 111 or provided on the cylindrical portion 112, for example.

### Liquid Discharge Structure

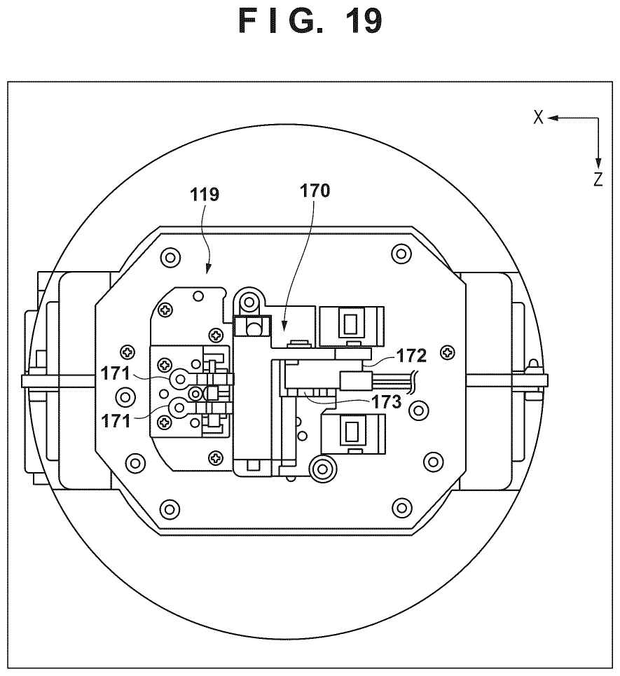

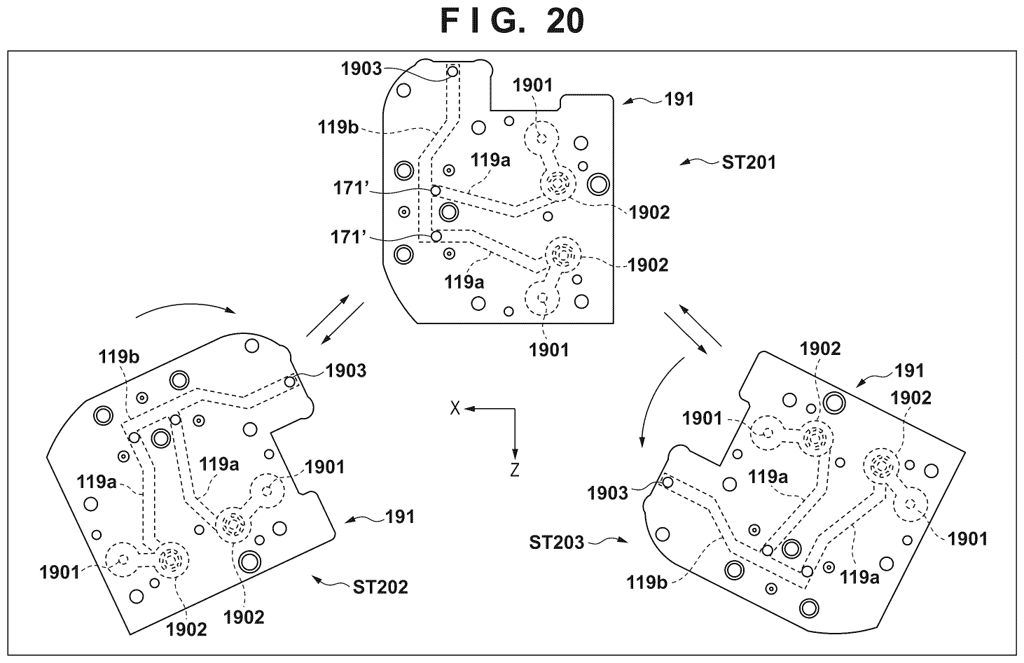

A structure for discharging liquid from the storage container 200 via the needle member 110a will now be described. A flow path forming member 119 is provided on the back end portion 111b between the back end portion 111b of the storage member 111 and the shaft fixing member 118. FIG. 19 is a diagram illustrating the flow path forming member 119 of the back end portion 111b of the storage member 111 and a valve unit 170 with the shaft fixing member 118 removed from the back end portion 111b. FIG. 20 illustrates an example of a flow path formed by the flow path forming member 119 and how the orientation of the flow path forming member 119 changes in conjunction with the rotation of the storage unit 110.

First, FIG. 20 will be referenced. The flow path forming member 119 forms a liquid flow path 119b and two liquid flow paths 119a branching from the flow path 119b. An outlet hole 1903 is formed in the end portion of the flow path 119b. A communication hole 1901 connecting to the needle member 110a of the upper and lower storage space 114 is formed on the end portion of each flow path 119a. A check valve 1902 is formed at an intermediate portion of each flow path 119a. The liquid inside the storage container 200 flows in order from the needle member 110a, the communication hole 1901, the flow paths 119a, the flow path 119b, the outlet hole 1903 and flows outside the storage unit 110.

A state ST201 indicates the orientation of the flow path forming member 119 when the storage unit 110 is at the initial position. A state ST202 indicates the orientation of the flow path forming member 119 when the storage unit 110 is in the left-inclined position (the state ST142 of FIG. 14). A state ST203 indicates the orientation of the flow path forming member 119 when the storage unit 110 is in the right-inclined position (the state ST143 of FIG. 14).

In a case where the storage unit 110 is in the initial position and the liquid stirring apparatus 100 has not been operated for a long amount of time, particles in the liquid may settle at the periphery of each branch position between the flow path 119b and the two flow paths 119a. However, in the present embodiment, when the storage unit 110 is rotated by the stirring action, the flow path forming member 119 also rotates, changing its orientation. Since the inclination of the flow paths 119a and 119b changes, the particles settled at the periphery of each branch position tend to flow together with the liquid. This can prevent the particles blocking the flow paths 119a and 119b.

The valve unit 170 illustrated in FIG. 19 is a motorized valve that switches between opening and closing the flow paths 119a at a position 171′ near each branch position between the flow path 119b and the two flow paths 119a. The valve unit 170 includes two valve bodies 171 corresponding to the two positions 171′, a motor 172 which is a drive source, and a position sensor 173 that detects the position of the two valve bodies 171. The valve bodies 171 are driven by the motor 172 via a built-in cam mechanism (not illustrated) in the valve unit 170 and are switched between opening and closing the flow paths 119a.

The valve unit 170 can select between closing both of the two flow paths 119a or opening one. For example, in a case where the storage container 200 storing the same type of liquid is stored in the two storage spaces 114, liquid is supplied from one storage container 200 and not supplied from the other storage container 200. When there is no more liquid remaining in one of the storage container 200, liquid is supplied from the other storage container 200 and not supplied from the first storage container 200. The storage container 200 with no remaining liquid can thereafter be replaced with a new storage container 200.

### Tube Routing Structure

A tube with flexibility is connected to the outlet hole 1903, and the liquid is supplied to the liquid discharge apparatus 1 via the tube. As illustrated in FIG. 20, the flow path forming member 119 is rotated in conjunction with the rotation of the storage unit 110, and the position of the outlet hole 1903 changes. When the position changes, the tube may twist, and this unintentional behavior may cause the tube to come into contact with the surrounding structures and cause damage. This needs to be prevented. In the present embodiment, a structure to control the behavior of the tube as the storage unit 110 rotates is applied to solve such a problem.

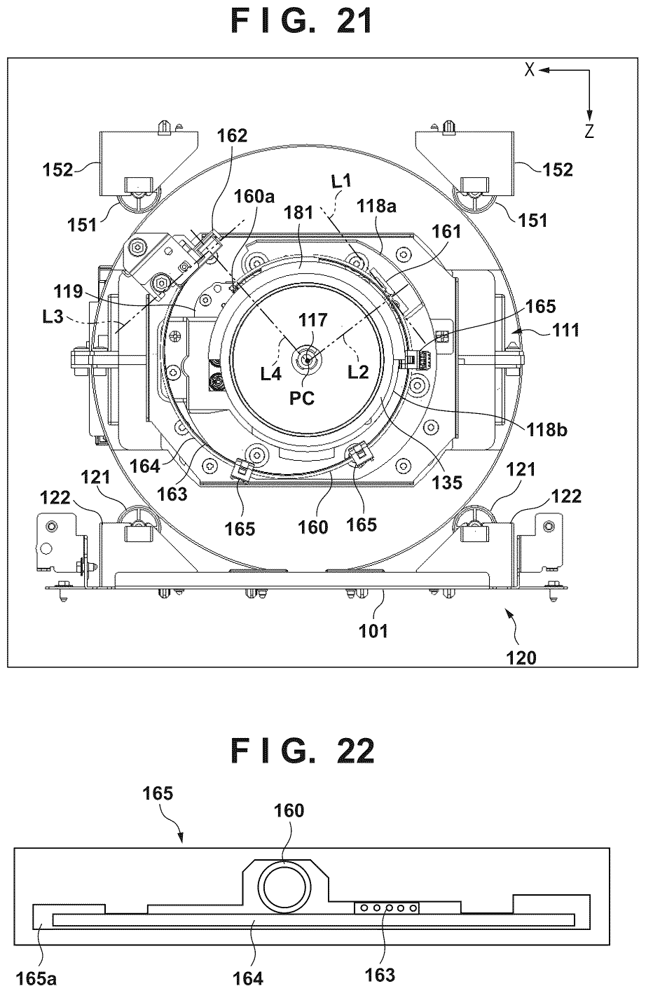

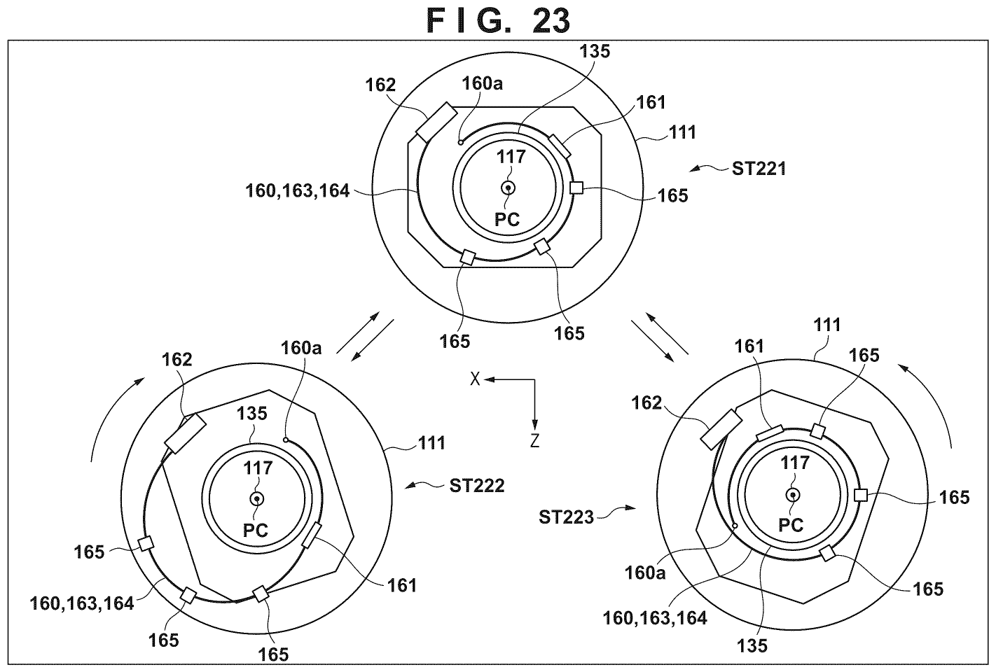

FIGS. 9, 13, 16, 17, and 21 to 23 will now be referenced. FIG. 21 is a back view illustrating the back portion of the storage unit 110 excluding the gear 135 and with the drive unit 130 removed. FIG. 22 is an explanatory diagram of a holding member 165. FIG. 23 is a diagram illustrating an example of changes in the form of a tube 160 when the storage unit 110 is rotated.

The tube 160 is connected to the outlet hole 1903 at an end portion 160a and extends from the storage unit 110. The tube 160 forms a discharge flow path for the liquid discharged from the storage unit 110 (in other words, the liquid of the storage container 200). A fixing member 161 is provided at the periphery of the barrel portion 118b of the shaft fixing member 118. The fixing member 161 is a clip-type member that pinches an intermediate portion of the tube 160 and fixes the intermediate portion of the tube 160 to the storage unit 110. The fixing member 161 rotates together with the storage unit 110 about the rotation center line CL.

The frame 103 is provided with a fixing member 162. The fixing member 162 is a clip-type member that fixes an intermediate portion of the tube 160 on the downstream side of the fixing member 161 in the liquid flow direction. Since the fixing member 162 is fixed to the frame 103, the fixing member 162 does not rotate together with the storage unit 110 and is an unmoving member. As illustrated in FIG. 9, the fixing members 161 and 162 are disposed on an imaginary plane VF orthogonal to the rotation center line CL. According to the present embodiment, the fixing members 161 and 162 are disposed on the same imaginary plane, but the imaginary plane VF where the fixing member 161 is disposed and the imaginary plane VF where the fixing member 162 is disposed may be offset from one another in the direction of the rotation center line CL. In this case, the tube 160 may be disposed in a helical shape extending in the rotation center line CL direction.

In a case where the storage unit 110 is at the initial position, as illustrated in FIG. 21, the fixing member 161 is at 2 o'clock and the fixing member 162 is at 10 o'clock if using an analogy of a clockface centered on the rotation center PC. The tube 160 extends from the end portion 160a, passes the upper side of the barrel portion 118b in the clockwise direction, and reaches the fixing member 161. Then it extends in the clockwise direction passing the lower side of the barrel portion 118b and reaches the fixing member 162. The tube 160 further extends from the fixing member 162 (FIG. 13). The tube 160 in FIGS. 21 and 22 is of the section from the end portion 160a to the fixing member 162. The fixing member 161 and the fixing member 162 are disposed at least on the inner side of the cylindrical portion 112 as seen from the Y direction. Accordingly, the movement area in the X direction of the tube 160 that rotates in conjunction with the rotation of the storage unit 110 can be reduced in size.

The fixing member 161 fixes an intermediate portion of the tube 160 to point it more in a tangent line direction L1 compared to a radial direction L2 of the imaginary circle on the X-Z plane centered on the rotation center PC. According to the present embodiment, the intermediate portion points in the tangent line direction L1. In a similar manner, the fixing member 162 fixes an intermediate portion of the tube 160 to point it more in a tangent line direction L3 compared to a radial direction L4 of the imaginary circle on the X-Z plane centered on the rotation center PC. According to the present embodiment, the intermediate portion points in the tangent line direction L3. Thus, in the tube section from the end portion 160a of the tube 160 to the fixing member 161 and the tube section from the fixing member 161 to the fixing member 162, the tube 160 is routed in an arc shape or a helical shape along the rotation center line CL. The fixing member 161 and the fixing member 162 each have a configuration in which the tube 160 is fixed in a direction substantially parallel with the tangent line direction L1 or L3. Accordingly, the expanding direction of the tube 160 rotating in conjunction with the rotation of the storage unit 110 is guided in the gravity direction. This reduces the load on the tube 160, allowing damage to the tube 160 to be reduced. Accordingly, since expansion of the tube 160 in the X direction is reduced, the size of the space in the X direction that the tube 160 can wiggle in can be reduced.

According to the present embodiment, the tube 160 is routed together with an electric cable (for example, a flexible flat cable) 163 and a band member 164 with flexibility in the tube section from the fixing member 161 to the fixing member 162.

The electric cable 163 includes an electronic component wiring line provided in the storage unit 110 such as an electrical wiring line of the motor 172 and the position sensor 173. As with the tube 160, the electric cable 163 is fixed at an intermediate portion by the fixing member 161 or fixed at an intermediate portion downstream from there by the fixing member 162. In the cable section from the fixing member 161 to the fixing member 162, the electric cable 163 is routed in an arc shape or a helical shape along the rotation center line CL. The tube 160, the electric cable 163, the fixing member 161, and the fixing member 162 are arranged more on the side of the back end portion 111b than the front end portion 111a of the storage member 111 and, in particular in the present embodiment, are arranged further back than the back end portion 111b. These configurations do not interfere with the task of inserting or removing the container support unit 24 by the user on the side of the front end portion 111a, thus allowing user-friendliness to be improved.

The band member 164 is a polyester film, for example. The band member 164 supports the tube 160 and the electric cable 163, further stabilizes the behavior of the tube 160 and the electric cable 163 when the storage unit 110 is rotated, and extends from the fixing member 161 to the fixing member 162.

Since the tube 160 and the electric cable 163 is integrally routed together with the band member 164, a plurality of the holding members 165 for holding these are used. The plurality of holding members 165 are arranged in the section from the fixing member 161 to the fixing member 162 and form a bundled member that integrally bundles together the tube 160 and the electric cable 163 with the band member 164. FIG. 23 is an explanatory diagram illustrating the structure of the holding member 165 that pinches each intermediate portion of the tube 160, the electric cable 163, and the band member 164 in a gap 165a. With the holding member 165, the tube 160, the electric cable 163, and the band member 164 can be prevented from separating out.

The behavior of the tube 160, the electric cable 163, and the band member 164 (hereinafter referred to as the tube 160 and the like) when the storage unit 110 is rotated will now be described with reference to FIG. 23. A state ST221 illustrates a state in which the storage unit 110 is in an initial position. The tube 160 and the like in the space from the fixing member 161 to the fixing member 162 have a moderate amount of slack or give.

A state ST222 indicates a state of the tube 160 and the like when the storage unit 110 is in the left-inclined position (the state ST142 of FIG. 14). Compared to the state ST221, in the state ST222, the length of the section between the fixing member 161 and the fixing member 162 in the clockwise direction in the same diagram is shorter, with the two approaching one another. In the section from the fixing member 161 to the fixing member 162, the amount of slack or give in the tube 160 and the like is increased, and the section takes on an arc shape with a large radius.

A state ST223 indicates a state of the tube 160 and the like when the storage unit 110 is in the right-inclined position (the state ST143 of FIG. 14). Compared to the state ST221, in the state ST223, the length of the section between the fixing member 161 and the fixing member 162 in the clockwise direction in the same diagram is longer, with the two separating from one another. In the section from the fixing member 161 to the fixing member 162, the amount of slack or give in the tube 160 and the like is decreased, and the section takes on an arc shape with a small radius. The tube 160 and the like approach the circumferential surface of the barrel portion 118b, but do not come into contact with it, and the tube 160 and the like do not come into contact with the valve unit 170.

Thus, in the routing mode according to the present embodiment, the radius of the arc shape made by the tube 160 and the like changes depending on the direction of the rotation of the storage unit 110. Thus, the behavior of the tube as the storage unit 110 is rotated can be controlled. As a result, twisting and unintentional behavior in the tube 160 and the like can be prevented.

### Control Circuit

The configuration of the control circuit of the system A will now be described with reference to FIG. 24. FIG. 24 is a block diagram of the control circuit of the system A. A main control unit 30 controls the entire system A in response to instructions from the host computer 300 and the control panel 10. A control unit 31 controls the liquid discharge apparatus 1 on the basis of instructions from the main control unit 30, and the control unit 32 controls the liquid storage apparatuses 20A and 20B on the basis of instructions from the main control unit 30. The main control unit 30 and the control units 31 and 32 include at least one processor, at least one storage device, and at least one I/O interface, for example. The storage device is a semiconductor memory such as RAM, ROM, or the like. The I/O interface performs the input and output of signals between the processor and an external device (sensor, motor, or the like).

A discharge control unit 35 controls the discharge head 8 and in particular performs liquid discharge control. An actuator group 34 includes a conveyance motor that is the drive source of the conveyance unit 6, a carriage motor that is the drive source of the movement mechanism of the carriage (not illustrated), a winding motor that is the drive source of the winding unit 5, and a recovery motor that is the drive source of the recovery unit 9. Also, the actuator group 34 includes a cutter motor and the like that is the drive source of a cutter (not illustrated) that cuts the printing medium M after image printing. A sensor group 33 includes various types of sensors provided in the liquid discharge apparatus 1.

A clock unit 38 is a counter that outputs the counting result of elapsed time to the control unit 32. In a case where the liquid stirring time period is managed using time, the counting result of the clock unit 38 can be used. Also, the stirring timing can also be determined using the counting result of the clock unit 38.

An actuator group 37 includes the motors 131 and 172 provided in the liquid stirring apparatus 100 and the flow path valve 232, and the like. A sensor group 36 includes the sensors 26 and 180 and the like provided in the liquid stirring apparatus 100.

### Control Circuit Processing Example

An example of processing executed by the control unit 32 relating to the stirring action will now be described. Here, the stirring action using the rotation restricting unit 140 will be described. The rotation restricting unit 140 is a structure that physically restricts the rotation range of the storage unit 110 as described above. However, by intentionally impacting the contact portion 115 and the contact portion 116 against the stoppers 141 and 142, a shock can be imparted to the storage unit 110. This can improve the liquid stirring effect. However, the contact portion 115 and the contact portion 116 coming into contact with the stoppers 141 and 142 may produce a hitting sound. Regarding this, an action condition may be set in advance, and one of the rotation actions described below with different rotation ranges for the storage unit 110 may be executed depending on whether or not the action condition is satisfied.

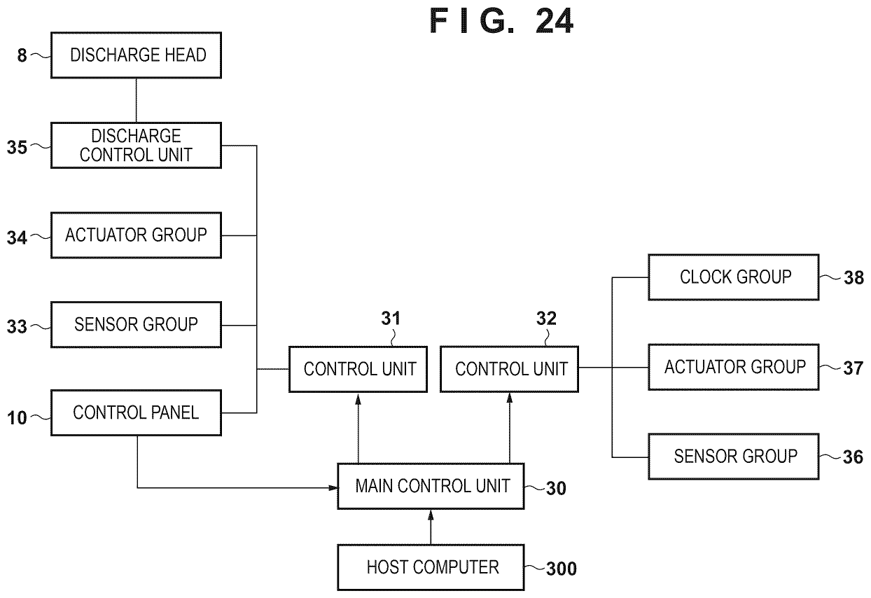

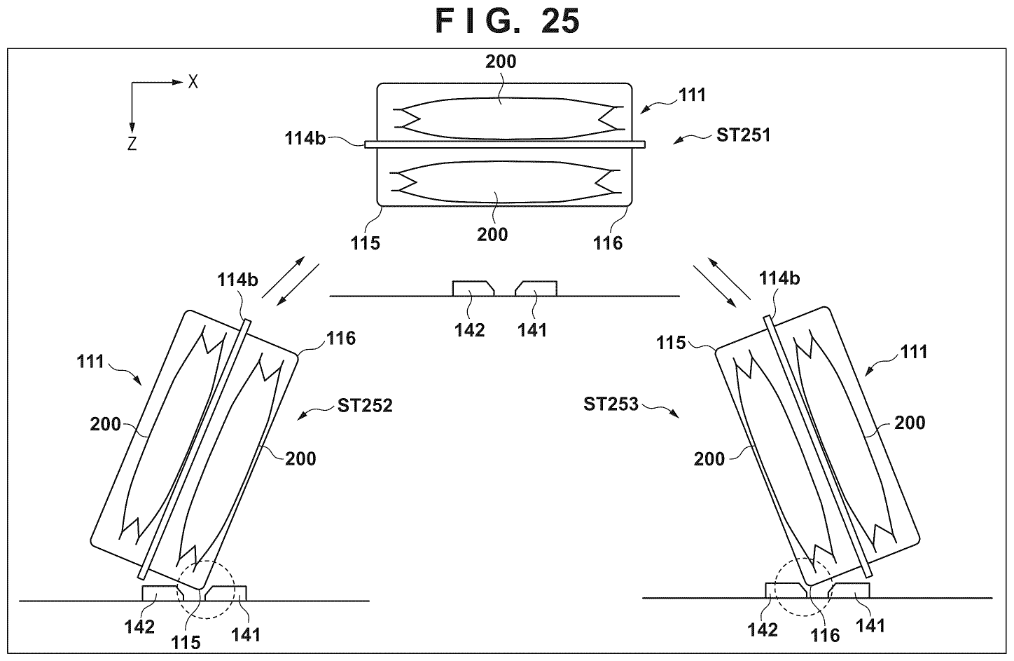

FIG. 25 illustrates an example of the rotation action of the storage unit 110 when a normal stirring effect is caused. A state ST251 illustrates a state in which the storage unit 110 is in an initial position. A state ST252 illustrates a state in which the storage unit 110 is rotated to the left-inclined position. At this time, the rotation direction of the storage unit 110 is switched to the reverse direction before the contact portion 115 comes into contact with the stopper 141. For example, the rotation amount of the motor 131 is controlled so that the rotation of the storage unit 110 stops before the contact portion 115 comes into contact with the stopper 141. Thereafter, the motor 131 is rotated in reverse. Since the contact portion 115 does not come into contact with the stopper 141, the hitting sound can be prevented.

A state ST253 illustrates a state in which the storage unit 110 is rotated to the right-inclined position. In a similar manner, the rotation direction of the storage unit 110 is switched to the reverse direction before the contact portion 116 comes into contact with the stopper 142. For example, the rotation amount of the motor 131 is controlled so that the rotation of the storage unit 110 stops before the contact portion 116 comes into contact with the stopper 142. Thereafter, the motor 131 is rotated in reverse. Since the contact portion 116 does not come into contact with the stopper 142, the hitting sound can be prevented.

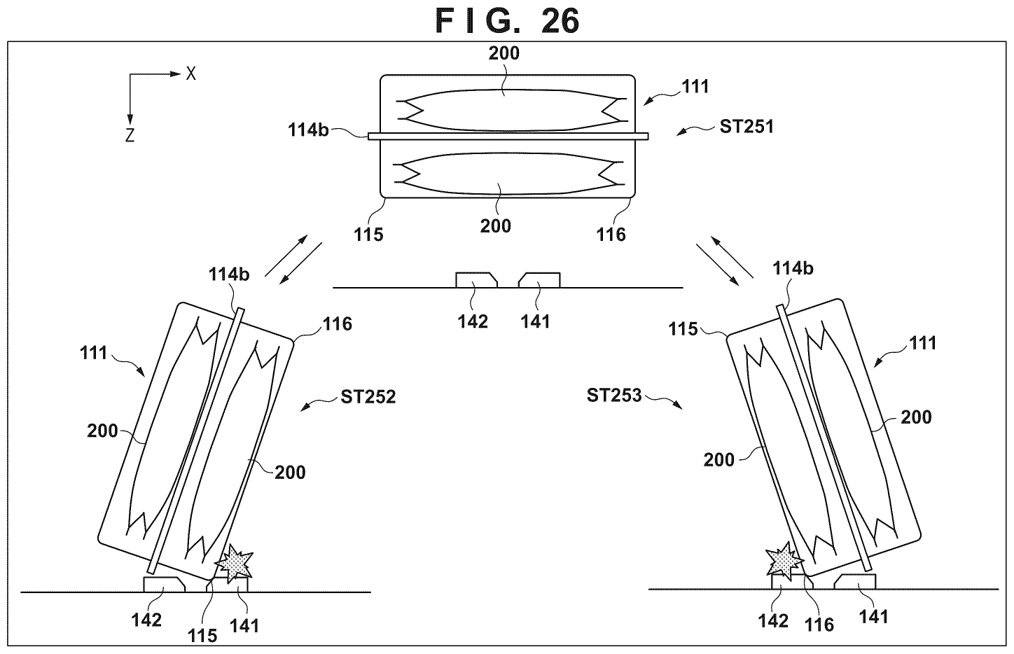

FIG. 26 illustrates an example of the rotation action of the storage unit 110 when a high stirring effect is caused. The rotation action, for example, is triggered when the power of the system A is turned on, when the power of the liquid stirring apparatus 100 is turned on, when the storage container 200 is replaced, when the storage container 200 is used after being in static storage for a long time, or the like.

A state ST261 illustrates a state in which the storage unit 110 is in an initial position. A state ST262 illustrates a state in which the storage unit 110 is rotated to the left-inclined position. At this time, the rotation direction of the storage unit 110 is switched to the reverse direction after the contact portion 115 comes into contact with the stopper 141. For example, the rotation amount of the motor 131 is controlled so that the rotation of the storage unit 110 continues until the contact portion 115 comes into contact with the stopper 141. Thereafter, the motor 131 is stopped and then rotated in reverse. Since the contact portion 115 comes into contact with the stopper 141, a shock impacts the storage unit 110. This improves the stirring performance of the liquid in the storage container 200. If a shock impacts the storage unit 110, the transfer of the shock to the motor 131 via the torque limiter 133a is stopped. Thus, the effects on the driving system can be reduced.

A state ST263 illustrates a state in which the storage unit 110 is rotated to the right-inclined position. In a similar manner, the rotation direction of the storage unit 110 is switched to the reverse direction after the contact portion 116 comes into contact with the stopper 142. For example, the rotation amount of the motor 131 is controlled so that the rotation of the storage unit 110 continues until the contact portion 116 comes into contact with the stopper 142. Thereafter, the motor 131 is stopped and then rotated in reverse. Since the contact portion 116 comes into contact with the stopper 142, a shock impacts the storage unit 110. This improves the stirring performance of the liquid in the storage container 200.

Note that with the rotation action of FIG. 26, control may be performed so that the shock impacts only at the inclined position on one side. Specifically, the rotation direction of the storage unit 110 is switched to the reverse direction after the contact portion 115 comes into contact with the stopper 141 at the left-inclined position. However, at the right-inclined position, before the contact portion 116 comes into contact with the stopper 142, the rotation direction of the storage unit 110 is switched to the reverse direction and the contact portion 116 is made not to come into contact with the stopper 142.

In the reverse pattern, the rotation direction of the storage unit 110 is switched to the reverse direction after the contact portion 116 comes into contact with the stopper 142 at the right-inclined position. However, at the left-inclined position, before the contact portion 115 comes into contact with the stopper 141, the rotation direction of the storage unit 110 is switched to the reverse direction and the contact portion 115 is made not to come into contact with the stopper 141.

In this manner, in a case where control is performed so that the shock impacts only the inclined position on one side, the combination of the impacting contact portion and the stopper may be changed depending on a predetermined condition. For example, in a case where a rotation action where the contact portion 115 and the stopper 141 impact is performed a predetermined number of times, the combination of the impacting contact portion and the stopper is changed to the contact portion 116 and the stopper 142. Then, in a case where a rotation action where the contact portion 116 and the stopper 142 impact is performed a predetermined number of times, again the combination of the impacting contact portion and the stopper is changed to the contact portion 115 and the stopper 141. The combination changing condition may be the rotation action time or time period instead of the number of times of the rotation action.

### Second Embodiment

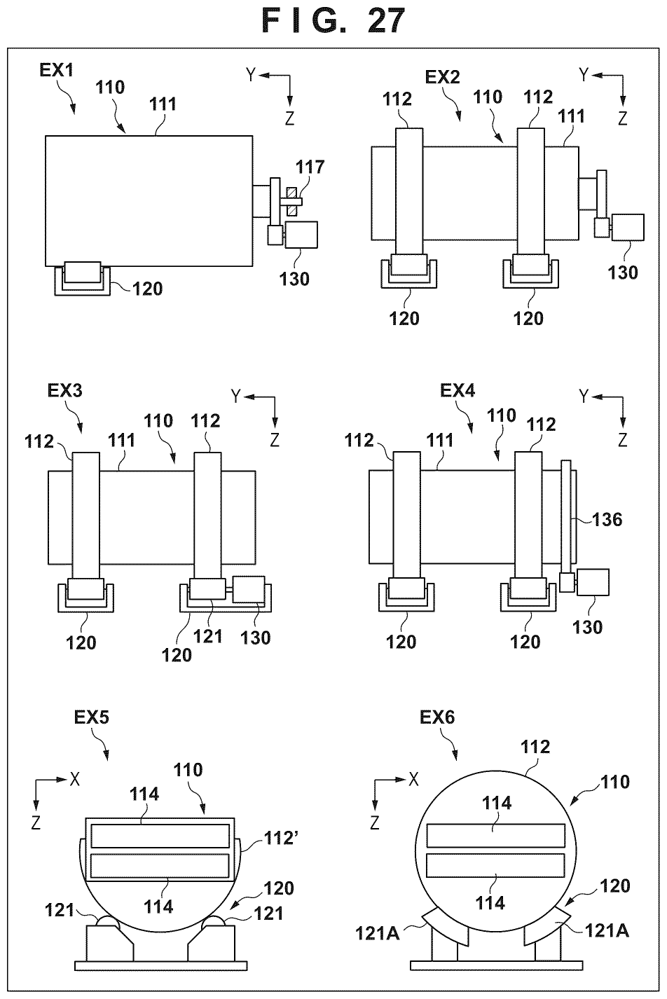

Another configuration example of the liquid stirring apparatus 100 will now be described with reference to FIGS. 27 to 29.

The storage member 111 according to the first embodiment includes the cylindrical portion 112 and the rectangular tube portion 113 at the outer wall portion 111c. However, as illustrated in configuration example EX1 of FIG. 27, the entire outer wall portion of the storage member 111 may be cylindrical.

Next, in the first embodiment described above, as the rotation support structure for the storage unit 110, a combination of the shaft-less support structure, that is the support unit 120, and the support structure with a shaft (the shaft member 117 and the bearing member 103a) is used. However, the storage unit 110 may be supported in a manner allowing for free rotation by only a shaft-less support structure. Configuration example EX2 of FIG. 27 illustrates this example, with two sets of the cylindrical portion 112 and the support unit 120 being separated in the direction of the rotation center line CL to support the storage unit 110. Accordingly, the shaft member 117 and the bearing member 103a are not required.

In the case of a configuration in which the storage unit 110 is supported in a manner allowing for free rotation by only a shaft-less support structure as in this example, as with configuration example EX3 of FIG. 27, the drive unit 130 may rotate the contact portion 121 (roller) which rotates the storage unit 110. Alternatively, as with configuration example EX4 of FIG. 27, the drive unit 130 may be provided with a gear 136, and the storage unit 110 may be rotated by transferring a driving force to the gear 136 fixed to the periphery of storage member 111.

Next, according to the configuration of the first embodiment, the cylindrical portion 112 extending around the entire circumference direction of the storage member 111 is provided and the cylindrical portion 112 is supported by the support unit 120. However, it is sufficient that the portion that the support unit 120 comes into contact with is within the rotation range of the storage unit 110. For example, as with configuration example EX5 of FIG. 27, an arc-shaped portion 112′ may be provided instead of the cylindrical portion 112, with the contact portions 121 of the support unit 120 coming into contact with the circumferential surface of the arc-shaped portion 112′.

Next, according to the configuration of the first embodiment, the contact portions 121 of the support unit 120 are rollers. However, instead of using a member that rolls such as a roller, a member that slides against the storage member 111 may be used. Configuration example EX6 of FIG. 27 is an example of this. Replacing the contact portions 121, contact portions 121A are members with a curved surface that the cylindrical portion 112 slides against and do not roll.

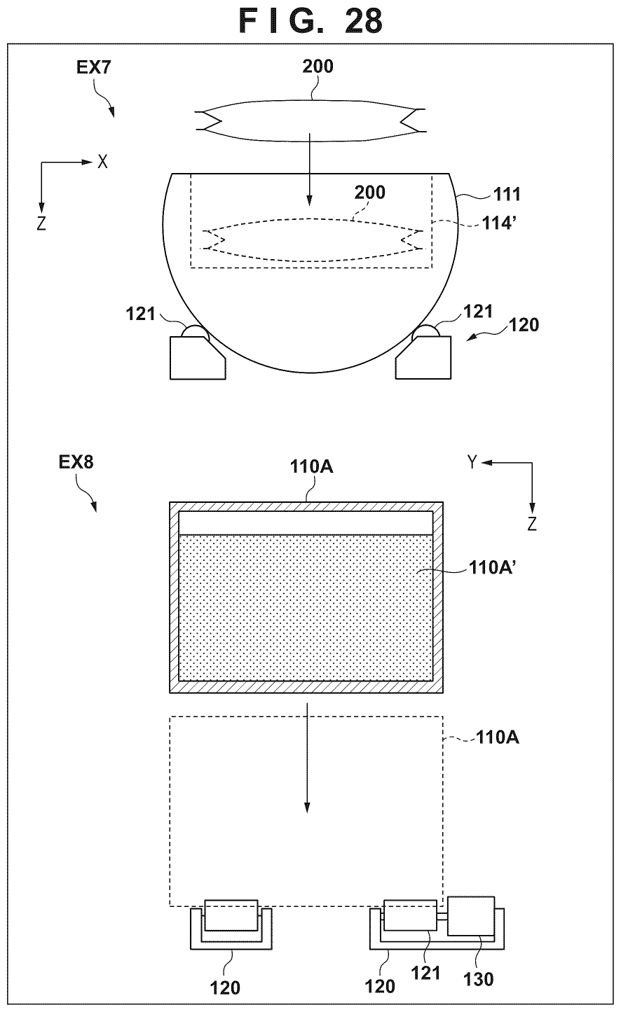

Next, according to the configuration of the first embodiment, the opening portion 114a of the storage space 114 opens to the front end portion 111a of the storage member 111 in the direction of the rotation center line CL. However, the opening portion may open in a direction intersecting the rotation center line CL. For example, configuration example EX7 of FIG. 28 illustrates a storage space 114′ that opens upward replacing the storage space 114. The storage container 200 (or the storage container 200 and the container support unit 24) is inserted or removed into/from the storage space 114′ in the up-and-down direction.

Next, according to the configuration of the first embodiment, the storage container 200 is replaceable with respect to the storage unit 110. However, the storage unit 110 may be a liquid tank functioning as the storage container 200. Configuration example EX8 of FIG. 28 illustrates this example, and a storage unit 110A is configured as a liquid tank. In the configuration example EX8, as with the support unit 120 in the configuration example EX3 of FIG. 27, the shaft-less support unit 120 only is used to support the storage unit 110A in a manner allowing for free rotation. Thus, in a case where there is no remaining liquid, the storage unit 110A is replaced as a unit.

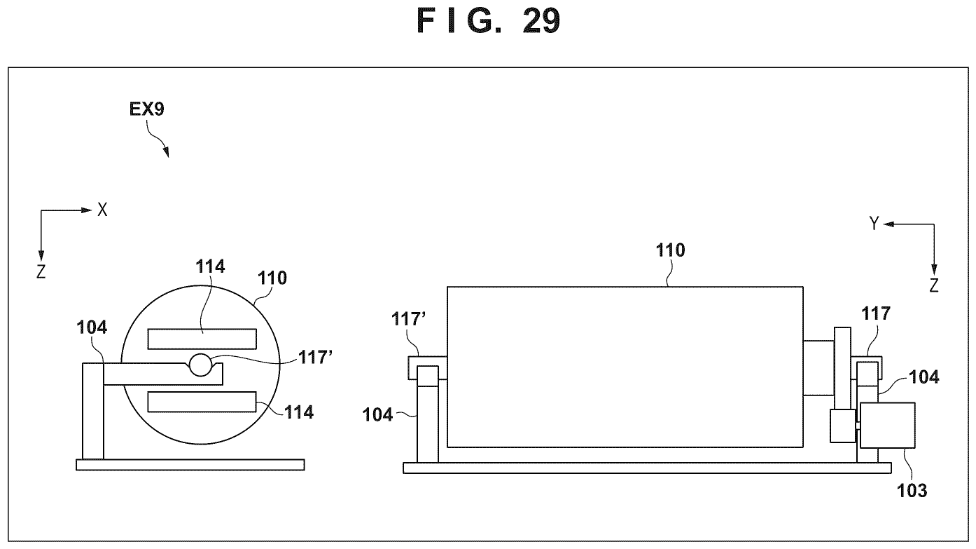

Next, in the first embodiment described above, as the rotation support structure for the storage unit 110, a combination of the shaft-less support structure, that is the support unit 120, and the support structure with a shaft (the shaft member 117 and the bearing member 103a) is used. However, the storage unit 110 may be supported in a manner allowing for free rotation by only a support structure with a shaft. Configuration example EX9 of FIG. 29 is an example of this. Not only is the shaft member 117 provided at the back end of the storage unit 110, but a shaft member 117′ is also provided at the front end. Each are supported by a bearing 104. The bearings 104 support the shaft members 117 and 117′ at a beam portion that extends horizontally. The beam portion and the shaft member 117′ are located between the two storage spaces 114 when the storage unit 110 is at the initial position so as to not significantly hinder the inserting or removing of the container support unit 24 into/from the storage space 114.

### Third Embodiment

A rotation action of the storage unit 110 may be performed via the drive unit 130 (see FIGS. 14, 25, and 26). Accordingly, a stirring effect can be caused in the liquid in the storage container 200 stored in the storage unit 110. However, there is a demand for improvement in the user-friendliness when the user uses a liquid storage apparatus 20B storing the liquid stirring apparatus 100.

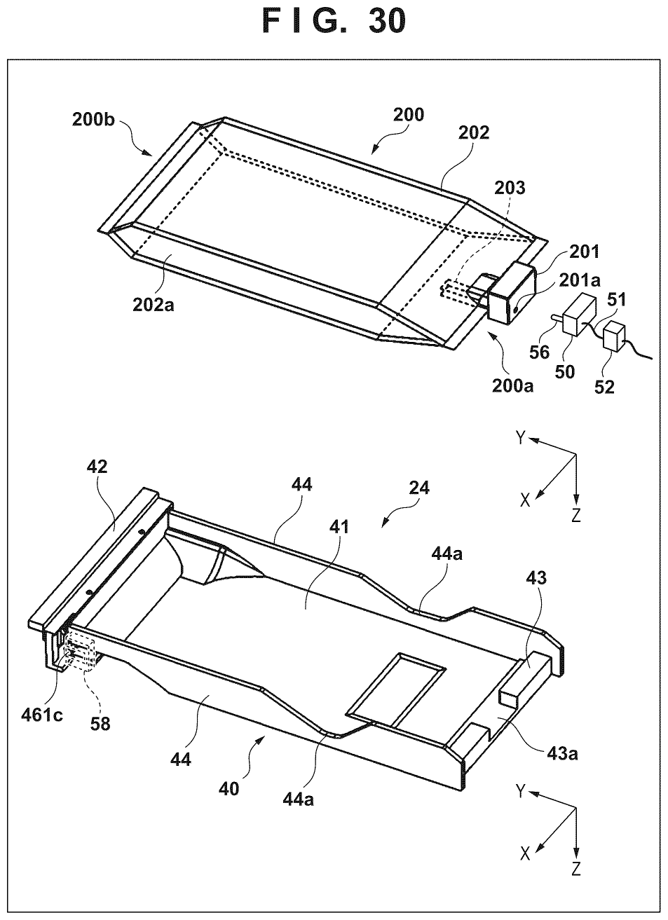

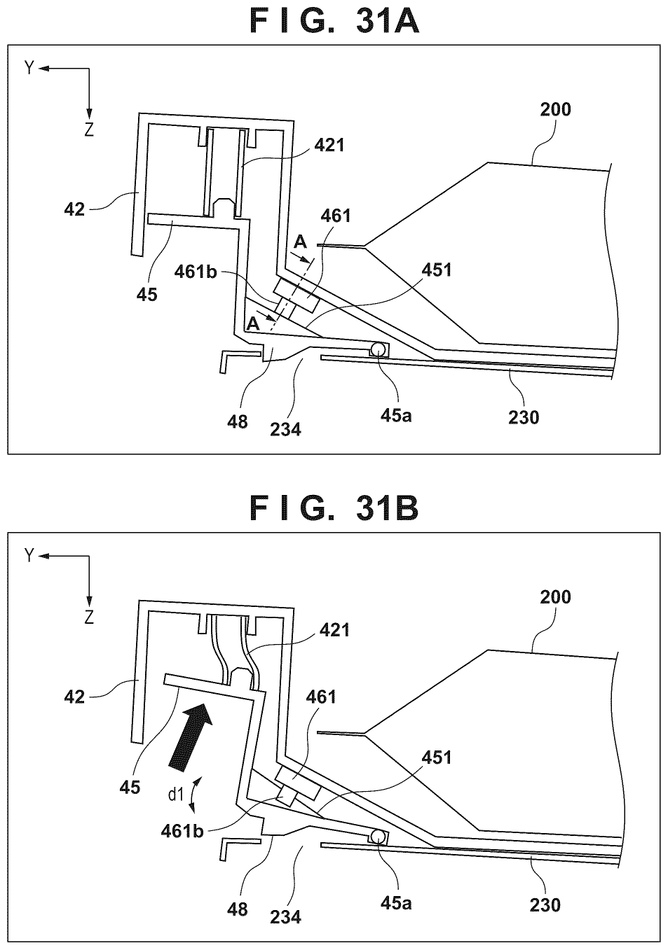

Another configuration example of the liquid storage apparatus 20B will now be described with reference to FIGS. 30 to 33. In the present embodiment, to prevent the container support unit 24 installed in the storage portion 23B from being inadvertently removed, a lock mechanism 46 that locks the container support unit 24 in a storage position is provided in the storage portion 23B (see FIGS. 31 to 33). The lock mechanism 46 is in other words a tray lock mechanism that locks the container support unit 24, a tray, into the opening portion 114a. The lock mechanism 46 is provided with a built-in slide member 461 in a front end portion 42. The slide member 461 includes an operation portion 461a exposed from the front end portion 42 that can be operated by the user. The slide member 461 is provided allowing for movement in an arrow d2 direction (X direction) between a locked position where rotation in a d1 direction of a handle 45 is restricted and a lock released position where rotation of the handle 45 is allowed.

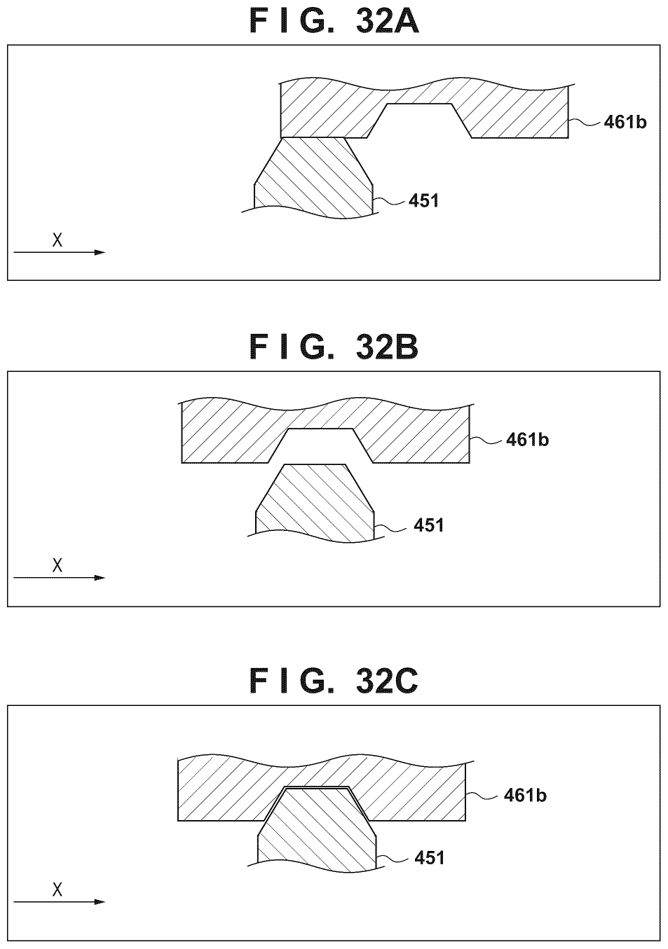

FIGS. 31A and 32A illustrate states with the slide member 461 located in the locked position. In other words, the lock mechanism 46 is in the locked state. The slide member 461 includes a contact portion 461b, and the contact portion 461b comes into contact with a contact portion 451 with a rib-shape provided on the handle 45. In the state illustrated in FIGS. 31A and 32A, the handle 45 cannot be turned in the engagement release direction due to the slide member 461 being in the way. Thus, the container support unit 24 cannot be removed from the storage portion 23B.

FIG. 32B illustrates a state with the slide member 461 located in the lock released position. In other words, the lock mechanism 46 is in the lock released state. The cutout portion of the contact portion 461b and the contact portion 451 are located facing one another. At this time, as illustrated in FIG. 32C, the contact portion 451 can escape from the cutout portion of the contact portion 461b. Thus, the handle 45 can turn in the engagement release direction as illustrated in FIG. 31B. In this manner, since the user can slider the slide member 461 to the lock released position before operating the handle 45, the container support unit 24 can be pulled out from the storage portion 23B.

The storage portion 23B is provided with a sensor 58 that detects the position of the slide member 461. For example, the sensor 58 is an optical sensor (for example, a photointerrupter) that can detect a detection piece 461c of the slide member 461. In a case where the slide member 461 is located at the locked position, as illustrated in FIG. 30, the detection piece 461c is located at the detection position of the sensor 58 and is detected by the sensor 58. In a case where the slide member 461 is located at the lock released position, the detection piece 461c is not located at the detection position of the sensor 58 and is not detected by the sensor 58. In this manner, whether the position of the slide member 461 is the locked position or the lock released position, that is, whether the lock mechanism 46 is in the locked state or the lock released state, can be determined on the basis of the detection result of the sensor 58.

The detection result of the sensor 58 can be linked to the opening and closing of a flow path valve 52. For example, in a case where the flow path valve 52 is in an open state, if the position of the slide member 461 is detected by the sensor 58 to be the lock released position, the flow path valve 52 is immediately closed in cooperation with the detection. In other words, in a case where the lock released state is detected by the sensor 58, the switching control is performed for the flow path valve 52 so that a tube 51 is closed. In this manner, the container support unit 24 coming out from the storage portion 23B when the flow path valve 52 is in the open state can be prevented. If the container support unit 24 comes out from the storage portion 23B when the flow path valve 52 is in the open state, air may enter inside the tube 51 from a flow path forming member 56. This may cause problems such as the solidification of the liquid in the tube 51 or poor discharge at the discharge head 8. When the position of the slide member 461 is detected to be the lock released position, in cooperation with the detection, the flow path valve 52 is immediately closed via automated control to prevent air being drawn into the tube 51.

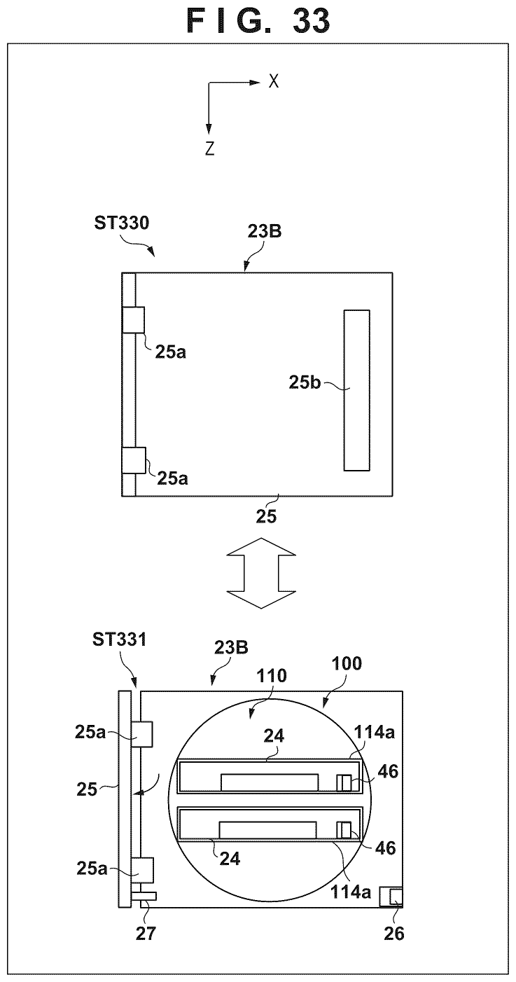

Cases where a user removes the storage container 200 from the storage unit 110 of the storage portion 23B are envisioned and described below. FIG. 33 will be referenced. FIG. 33 is a front view of the storage portion 23B, with a state ST330 illustrating the opening and closing member 25 is a closed state and a state ST331 illustrating the opening and closing member 25 in an open state.

As illustrated in the state ST330, the storage unit 110 is in a state where it is covered by the opening and closing member 25. In other words, the opening and closing member 25 is arranged in the closed state of the open and closed state covering the opening portion 114a. Thus, in a case where the user wishes to remove the storage container 200 from the storage unit 110, as illustrated in the state ST331, the opening and closing member 25 needs to be put in the open state. The storage unit 110 includes the storage member 111 that stores the storage container 200 of liquid as described above and the opening portion 114a where the storage container 200 is insert and removed into/from the storage member 111 (see FIGS. 8 to 11). The storage container 200 is stored in the storage member 111 in a state set in the container support unit 24, and the storage container 200 is inserted or removed via the opening portion 114a together with the container support unit 24. Here, in the state ST331, the storage unit 110 has not been rotated by the drive unit 130 and is stopped in the initial position. The initial position is a position where the storage container 200 stored in the storage unit 110 has a horizontal orientation, for example. In other words, the initial position is also a position where the container support unit 24 that supports the storage container 200 has a horizontal orientation and a position where the opening portion 114a where the container support unit 24 is inserted has a horizontal orientation. In this manner, in a case where the opening and closing member 25 is put in the open state, with the storage container 200 stopped in the initial position, the user can easily pull out the container support unit 24 from the opening portion 114a and removed the storage container 200.

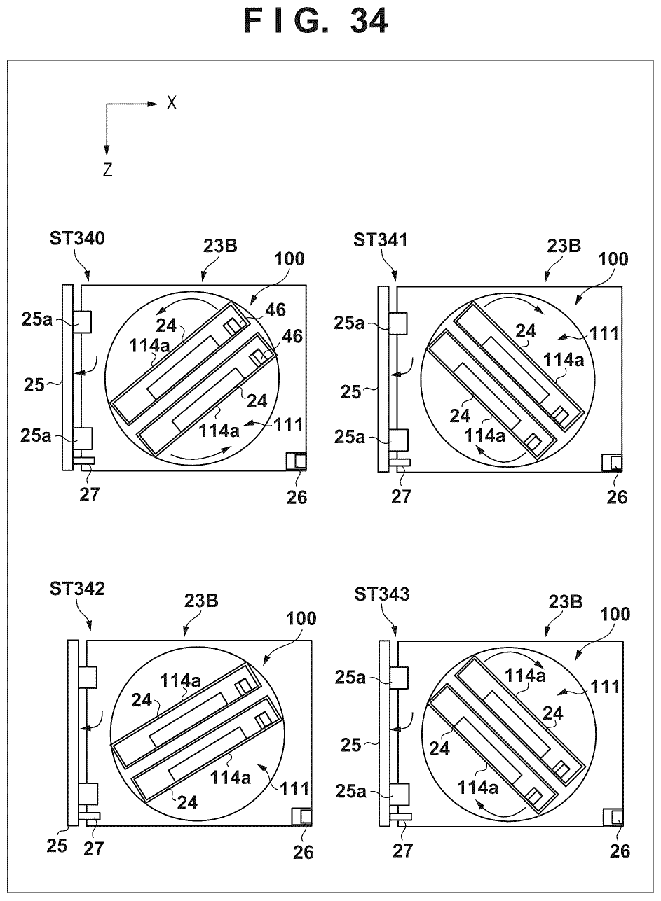

However, as described above, the storage unit 110 may be rotated by the drive unit 130. Here, FIG. 34 will be referenced. FIG. 34 is a front view of the storage portion 23B, with states ST340 to ST343 illustrating examples of states where the opening and closing member 25 is open.

As illustrated in the state ST340, when the opening and closing member 25 is opened, the storage unit 110 may be rotated to the left-inclined position by the rotation action described above. Also, as illustrated in the state ST341, the storage unit 110 may be rotated to the right-inclined position by the rotation action. As with the states ST340 to ST341, if the storage unit 110 is in a rotated state, it may be difficult to replace the storage container 200. Accordingly, in the present embodiment, in a case where a rotation stop condition relating to the state of the opening and closing member 25 is satisfied, the rotation of the storage unit 110 is stopped by the drive unit 130. Specifically, in the configuration according to the present embodiment described below, with the rotation stop condition being the open/closed state of the opening and closing member 25 being the open state, the rotation of the storage unit 110 is stopped by the drive unit 130.

As illustrated in the state ST342, when the opening and closing member 25 is opened, the storage unit 110 may be stopped at the left-inclined position due to rotation. Also, as illustrated in the state ST343, the storage unit 110 may be stopped at the right-inclined position due to rotation. As illustrated in the state ST342 to ST343, compared to when the storage unit 110 is in an inclined orientation, it is easier for the user to pull out the container support unit 24 and remove the storage container 200 when the storage unit 110 is in a horizontal orientation as in the state ST331 of FIG. 33. When the storage unit 110 is in an inclined orientation, the storage container 200 may be twisted, and removal of the container support unit 24 may be inhibited. Thus, in the configuration according to the present embodiment described below, after the rotation of the storage unit 110 by the drive unit 130 is stopped, the storage unit 110 is rotated to a horizontal orientation.

### Control Circuit Processing Example

An example of control by the control unit 32 according to the present embodiment will now be described with reference to FIG. 35. FIG. 35 is a flowchart illustrating an example of processing executed by the control unit 32. The processing of FIG. 35 is executed by the control module of the control unit 32 loading a control program stored in the memory such as a ROM onto the RAM and executing the control program.

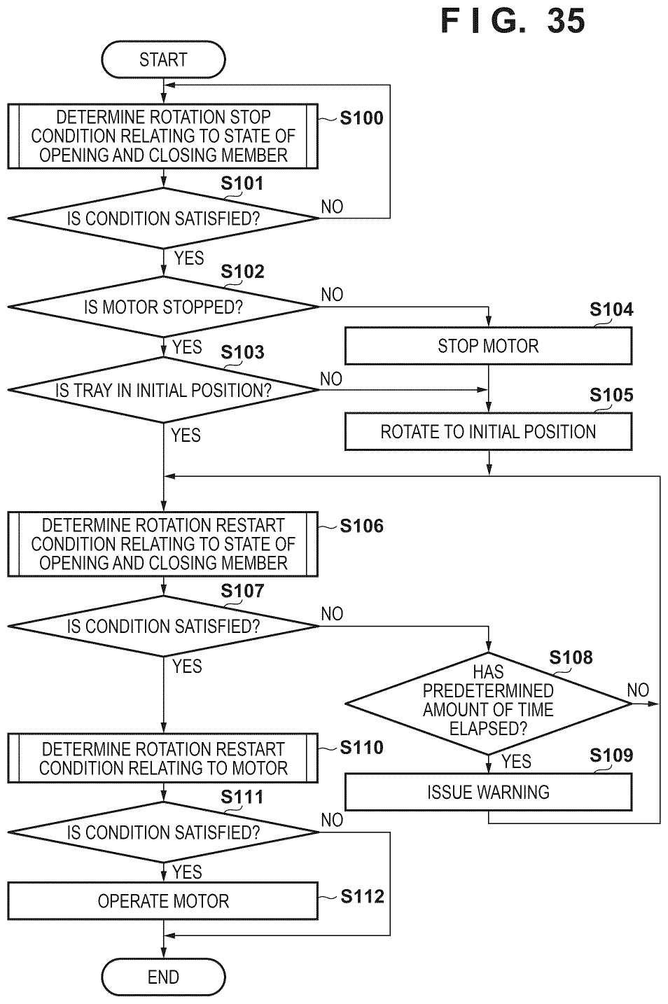

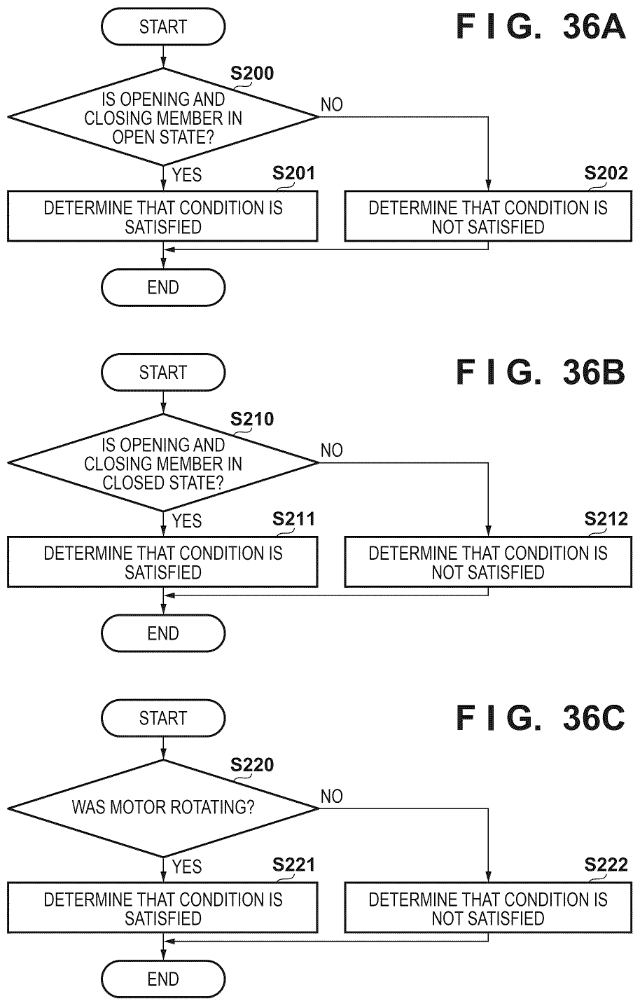

In step S100, the control unit 32 determines the rotation stop condition relating to the state of the opening and closing member 25. The present processing will be described with reference to FIG. 36A. FIG. 36A is a flowchart illustrating an example of the processing executed in step S100 by the control unit 32. Note that the processing of FIGS. 36A to 36C is executed by the control module of the control unit 32 loading a control program stored in the memory such as a ROM onto the RAM and executing the control program.

In step S200, the control unit 32 determines whether or not the opening and closing member 25 is in the open state. In a case where the control unit 32 determines that the opening and closing member 25 is in the open state, the control unit 32 proceeds to step S201. However, in a case where the control unit 32 determines that the opening and closing member 25 is not in the open state, the control unit 32 proceeds to step S202. The control unit 32, for example, performs the present determination on the basis of the detection result of the sensor 26 that detects the open/closed state of the opening and closing member 25. In step S201, the control unit 32 determines that the rotation stop condition is satisfied. In step S202, the control unit 32 determines that the rotation stop condition is not satisfied. In this manner, in the present embodiment, the rotation stop condition for the control unit 32 to stop the rotation of the storage unit 110 by the drive unit 130 is the open/closed state detected by the sensor 26 being the open state.

In step S101, the control unit 32 determines whether or not the rotation stop condition is satisfied. In a case where the control unit 32 determines that the rotation stop condition is satisfied, the control unit 32 proceeds to step S102. However, in a case where the control unit 32 determines that the rotation stop condition is not satisfied, the control unit 32 executes the processing of step S100 again. In step S101, specifically, the control unit 32 executes determination on the basis of the processing result of step S200.

In step S102, the control unit 32 determines whether or not the motor 131 is stopped. In a case where the control unit 32 determines that it is stopped, the control unit 32 proceeds to step S103. In a case where the control unit 32 determines that it is not stopped, the control unit 32 proceeds to step S104. The control unit 32 may perform the present determination on the basis of the rotation amount of the motor 131, for example. Also, the control unit 32 may perform the present determination on the basis of the detection result of the sensor 180, for example.

In step S103, the control unit 32 determines whether or not the container support unit 24 is in the initial position. In other words, the control unit 32 determines whether or not the opening portion 114a is in a horizontal orientation. In a case where the control unit 32 determines that it is in the initial position, the control unit 32 proceeds to step S106. However, in a case where the control unit 32 determines that it is not in the initial position, the control unit 32 proceeds to step S105. The control unit 32 may perform the present determination on the basis of the detection result of the sensor 180, for example. Also, the control unit 32 may use the rotation amount of the motor 131 from the initial position as a pulse count, for example, and perform the present determination on the basis of the count result.

In step S104, the control unit 32 performs control to stop the motor 131. In this manner, in the present embodiment, in a case where a rotation stop condition relating to the state of the opening and closing member 25 is satisfied, the rotation of the storage unit 110 is stopped by the drive unit 130. According to the processing of step S104, for example, even in a case where the storage unit 110 has been rotated by the drive unit 130 as in the states ST340 and ST341 of FIG. 34, the storage unit 110 can be put in a stopped state such as that illustrated in the states ST342 and ST343. According to this embodiment, for example, the user-friendliness for the user when removing the storage container 200 of liquid from the storage unit 110 can be improved.

In step S105, the control unit 32 causes the drive unit 130 to drive the storage unit 110 to rotate so that the container support unit 24 is put at the initial position. Also, in a case where the container support unit 24 is put in the initial position, the control unit 32 controls the drive unit 130 to stop the rotation of the storage unit 110. The control unit 32 may perform the control of step S105 on the basis of the detection result of the sensor 180, for example. Also, the control unit 32 may use the rotation amount of the motor 131 from the initial position as a pulse count, for example, and perform the control of step S105 on the basis of the count result.

According to the processing of step S105, for example, even if the opening portion 114a where the storage container 200 is stored an inclined orientation as illustrated in the states ST342 and ST343 of FIG. 34, the opening portion 114a can be put in a horizontal orientation as illustrated in the state ST331 of FIG. 33. In other words, in a case where the rotation stop condition relating to the state of the opening and closing member 25 is satisfied, the rotation of the storage unit 110 is stopped so that the opening portion 114a where the container support unit 24 is inserted is put in a horizontal orientation. According to this embodiment, for example, it can be made easier for the user to remove the container support unit 24 from the storage unit 110, further improving the user-friendliness.

In step S106, the control unit 32 determines the rotation restart condition relating to the state of the opening and closing member 25. The present processing will be described with reference to FIG. 36B. FIG. 36B is a flowchart illustrating an example of the processing executed in step S106 by the control unit 32. The control unit 32 determines whether or not the opening and closing member 25 is in the closed state in step S210. In a case where the control unit 32 determines that the opening and closing member 25 is in the closed state, the control unit 32 proceeds to step S211. However, in a case where the control unit 32 determines that the opening and closing member 25 is not in the closed state, the control unit 32 proceeds to step S212. The control unit, for example, performs the present determination on the basis of the detection result of the open/closed state of the opening and closing member 25 from the sensor 26. In step S211, the control unit 32 determines that the rotation restart condition is satisfied. In step S212, the control unit 32 determines that the rotation restart condition is not satisfied. In this manner, in the present embodiment, the rotation restart condition for the control unit 32 to restart the rotation of the storage unit 110 by the drive unit 130 includes the opening and closing member 25 detected by the sensor 26 being in the closed state. According to this embodiment, rotation of the storage unit 110 being restarted when the opening and closing member 25 is in the open state can be prevented.

In step S107, the control unit 32 determines whether or not the rotation restart condition is satisfied. In a case where the control unit 32 determines that the rotation restart condition is satisfied, the control unit 32 proceeds to step S110. However, in a case where the control unit 32 determines that the rotation restart condition is not satisfied, the control unit 32 proceeds to step S108. In step S107, specifically, the control unit 32 executes determination on the basis of the processing result of step S210.

In step S108, the control unit 32 determines whether or not a predetermined amount of time has elapsed. In a case where the control unit 32 determines that the predetermined amount of time has elapsed, the control unit 32 proceeds to step S109. However, in a case where the control unit 32 determines that the predetermined amount of time has not elapsed, the control unit 32 executes the processing of step S106 again. The predetermined amount of time may be set within a range from 0 seconds to 1 hour, for example. In particular, the predetermined amount of time may be set within a range from 0 seconds to 30 minutes. Also, the predetermined amount of time may be preferably set to a range from 0 seconds to 15 minutes or from 15 minutes to 30 minutes.

In step S109, the control unit 32 issues a warning. In other words, in a case where, after the rotation stop condition is satisfied and the rotation of the storage unit 110 by the drive unit 130 is stopped, the sensor 26 has not detected the closed state within the predetermined amount of time, a warning is issued by the control unit 32. The warning may be a notification prompting the user to put the opening and closing member 25 in the closed state. Also, the warning may be a notification prompting the user to perform stirring by manually rotating the storage container 200. Also, the liquid storage apparatus 20B may be provided with a display unit (not illustrated) such as a display, light-emitting element, or the like that displays the warning. In step S109, the control unit 32 may perform control to display the warning on the display unit (not illustrated). Also, the liquid storage apparatus 20B may be provided with a speaker (not illustrated) for notifications of the warning via audio. In step S109, the control unit 32 may perform control to notify the user of the warning via the speaker (not illustrated). In this configuration, the processing returns to step S106 after the warning is issued in step S109. However, in another configuration, after the warning is issued, the present flow may end.

In step S110, the control unit 32 determines the rotation restart condition relating to the motor 131. The present processing will be described with reference to FIG. 36C. FIG. 36C is a flowchart illustrating an example of the processing executed in step S110 by the control unit 32. The control unit 32 determines whether or not the motor 131 was rotating in step S220. In a case where the control unit 32 determines that the motor 131 was rotating, the control unit 32 proceeds to step S221. However, in a case where the control unit 32 determines that the motor 131 was not rotating, the control unit 32 proceeds to step S222. In step S220, in a case where the control unit 32 determines stopped for step S102 described above (YES in step S102), for example, the control unit 32 determines that the motor 131 was not rotating. However, in step S220, in a case where the control unit 32 determines not stopped for step S102 described above (NO in step S102), for example, the control unit 32 determines that the motor 131 is rotating. In step S221, the control unit 32 determines that the rotation restart condition is satisfied. In step S222, the control unit 32 determines that the rotation restart condition is not satisfied. In this manner, in the present embodiment, the rotation restart condition for the control unit 32 to restart the rotation of the storage unit 110 by the drive unit 130 includes that the motor 131 was rotating when the rotation stop condition was satisfied. According to this embodiment, for example, while the storage unit 110 is rotated by the drive unit 130, even if the rotation is stopped by the opening and closing member 25 being put in an open state, the rotation can be restarted.

In step S111, the control unit 32 determines whether or not the rotation restart condition is satisfied. In a case where the control unit 32 determines that the rotation restart condition is satisfied, the control unit 32 proceeds to step S112. However, in a case where the control unit 32 determines that the rotation stop condition is not satisfied, the control unit 32 ends the processing of FIG. 35. In step S111, specifically, the control unit 32 executes the present determination on the basis of the processing result of step S220.

In step S112, the control unit 32 performs control so that the operation of the motor 131 is restarted. In other words, the control unit 32 performs control to restart the rotation of the storage unit 110 by the drive unit 130.

Note that in the present example described above, the control unit 32 proceeds to step S106 after the processing of step S105. However, no such limitation is intended. For example, after the processing of step S105, the control unit 32 may perform control to restrict the rotation of the storage unit 110 by the drive unit 130 before proceeding to step S106. Specifically, for example, the control unit 32 controls the drive unit 130 to drive the motor 131 in a weak magnetic excitation state. According to the present processing, in a case where the rotation of the storage unit 110 is stopped, the drive unit 130 drives the restriction of rotation of the storage unit 110.

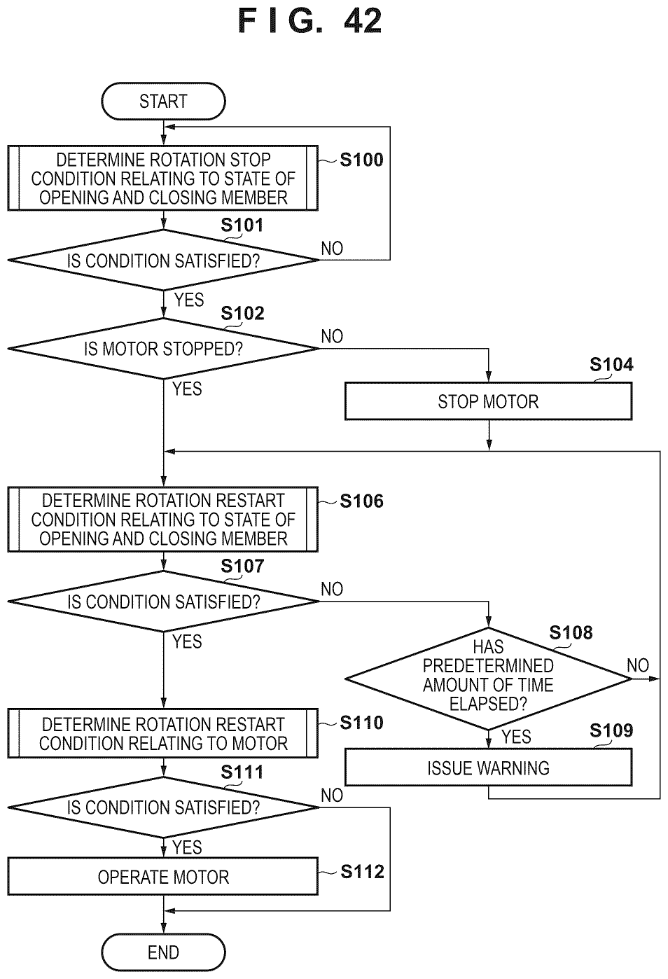

Note that in the present example, in step S103, whether or not the opening portion 114a is in a horizontal orientation is determined, and in a case where it is not in a horizontal orientation, the processing proceeds to step S105 where the storage unit 110 is rotated so that the container support unit 24 is put in the initial position. However, as illustrated in FIG. 42, control may be performed that does not include steps S103 and S105. In this case, the user pulls out the container support unit 24 with the container support unit 24 still in an inclined orientation with respect to the horizontal plane. However, for example, in a case where the capacity of the storage container 200 is small, twisting is unlikely to occur, and thus the pulling out operation is unlikely to be inhibited. By performing control to stop the operation of the motor 131 when the opening and closing member 25 is detected in the open state, the ease of use for the user can be improved. Also, the predetermined amount of time of step S108 in this case is used in a case where the container support unit 24 is inclined with respect to the horizontal direction and is preferably set to a smaller value than that for the case of FIG. 35 because sedimentation of the particles occurs quicker compared to when the container support unit 24 is in a horizontal orientation. For example, the predetermined amount of time may be set within a range from 0 seconds to 30 minutes and in particular within a range from 0 seconds to 15 minutes. Also, the predetermined amount of time may be preferably set within a range from 1 minute to 3 minutes. Alternatively, the predetermined amount of time may be changed depending on the inclination angle of the container support unit 24 with respect to the horizontal direction. In this case, preferably, the larger the inclination angle with respect to the horizontal direction the shorter the predetermined amount of time.

### Fourth Embodiment

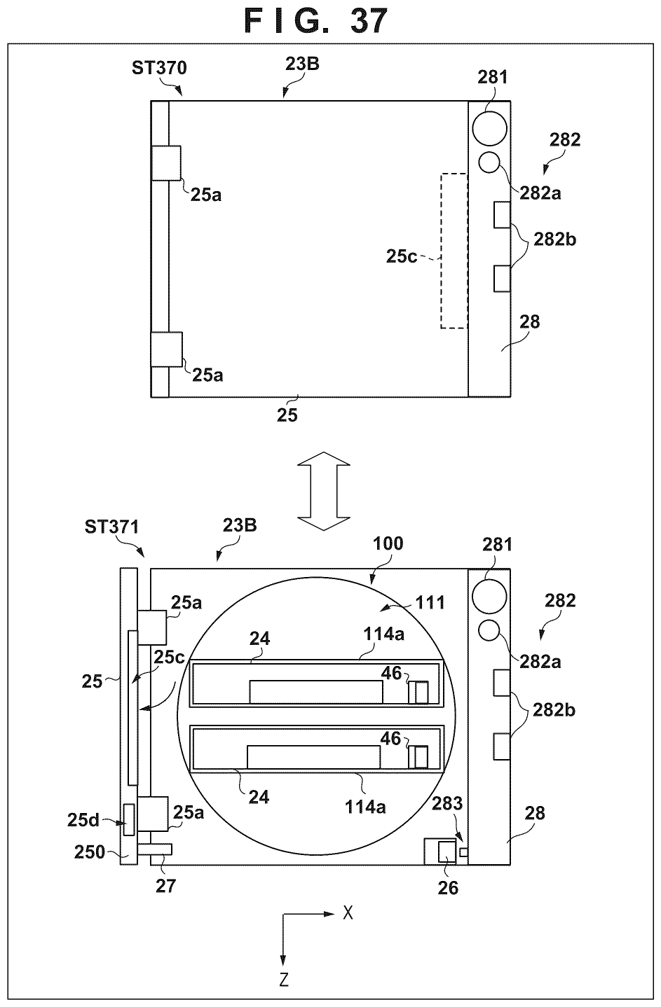

Another configuration example of the liquid storage apparatus 20B will now be described with reference to FIGS. 37 to 39. First, FIG. 37 will be referenced. FIG. 37 is a front view of the storage portion 23B, with a state ST370 illustrating the opening and closing member 25 is a closed state and a state ST371 illustrating the opening and closing member 25 in an open state.

In the present embodiment illustrated in FIG. 37, the liquid storage apparatus 20B includes a frame portion 28 provided on the opening portion 114a side of the storage unit 110 together with the opening and closing member 25. The frame portion 28 is a cover covering one end of the front surface side of the storage member 111. In a case where the opening and closing member 25 is in the closed state, the frame portion 28 is provided adjacent to the opening and closing member 25. The frame portion 28, as described below, is provided with a closed lock mechanism 280 that locks the opening and closing member 25 in the closed state. Also, the frame portion 28 is provided with an operation unit 281 that receives a release operation for the locking of the opening and closing member 25 by the closed lock mechanism 280. The operation unit 281 is a button, for example. Note that the operation unit 281 may be a touch panel or the like, for example.

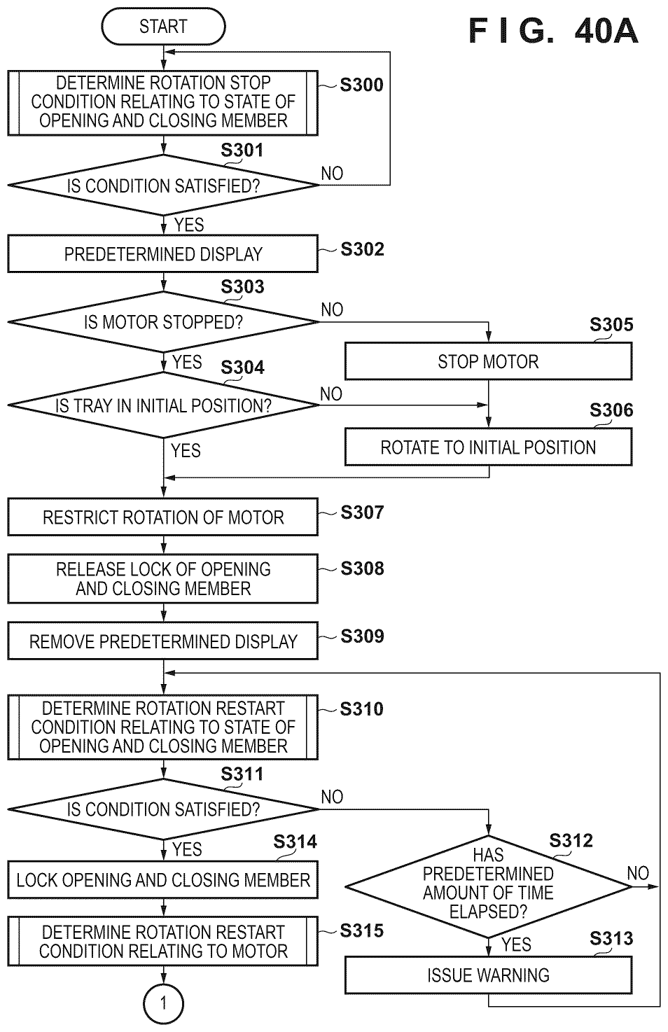

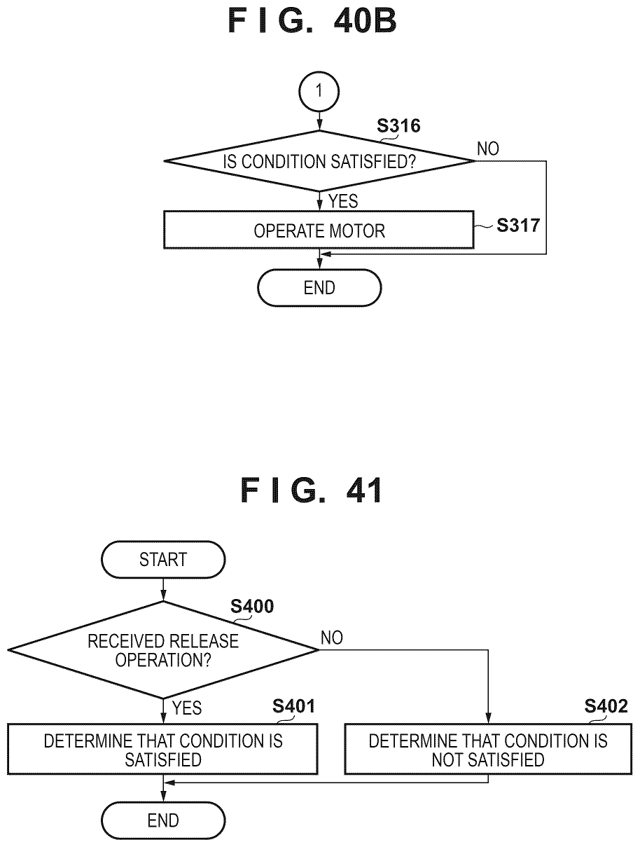

In the third embodiment, the rotation stop condition includes the opening and closing member 25 being in an open state. In the present embodiment, the rotation stop condition includes the operation unit 281 having received a release operation. For example, in a case where the user presses the operation unit 281, the rotation of the storage unit 110 by the drive unit 130 is stopped. In this manner, even in a case where the liquid storage apparatus 20B is provided with the closed lock mechanism 280 that locks the opening and closing member 25 in a closed state, the rotation of the storage unit 110 can be stopped by a release operation of the closed lock mechanism 280. An example of control by the control unit 32 according to the present embodiment will be described below using FIGS. 40 and 41.

Also, the frame portion 28 is provided with a display unit 282 that performs a predetermined display until the lock of the closed lock mechanism 280 is released in a case where the operation unit 281 has received a release operation. The display unit 282 includes a light-emitting element 282a provided adjacent to the operation unit 281. Also, the display unit 282 includes a light-emitting element 282b disposed on the frame portion 28 at a position aligned with the opening portion 114a in a case where the opening portion 114a is in a horizontal orientation. The light-emitting element 282a and the light-emitting element 282b may be LEDs, for example. The display unit 282 may flash at least one of the light-emitting element 282a and the light-emitting element 282b as a predetermined display until the rotation of the storage unit 110 by the drive unit 130 is stopped, for example. Also, the display unit 282 may flash at least one of the light-emitting element 282a and the light-emitting element 282b as a predetermined display to display the time until the lock of the closed lock mechanism 280 is released. Note that in the present embodiment described above, the light-emitting element 282a and the light-emitting element 282b are examples of the display unit 282. However, no such limitation is intended. For example, the display unit 282 may be a display. Also, the display unit 282 may display that the storage unit 110 is still rotating. Also, for example, using a speaker (not illustrated) or the like, the user may be notified of the time until the lock of the closed lock mechanism 280 is released, be notified that the storage unit 110 is still rotating, or the like.

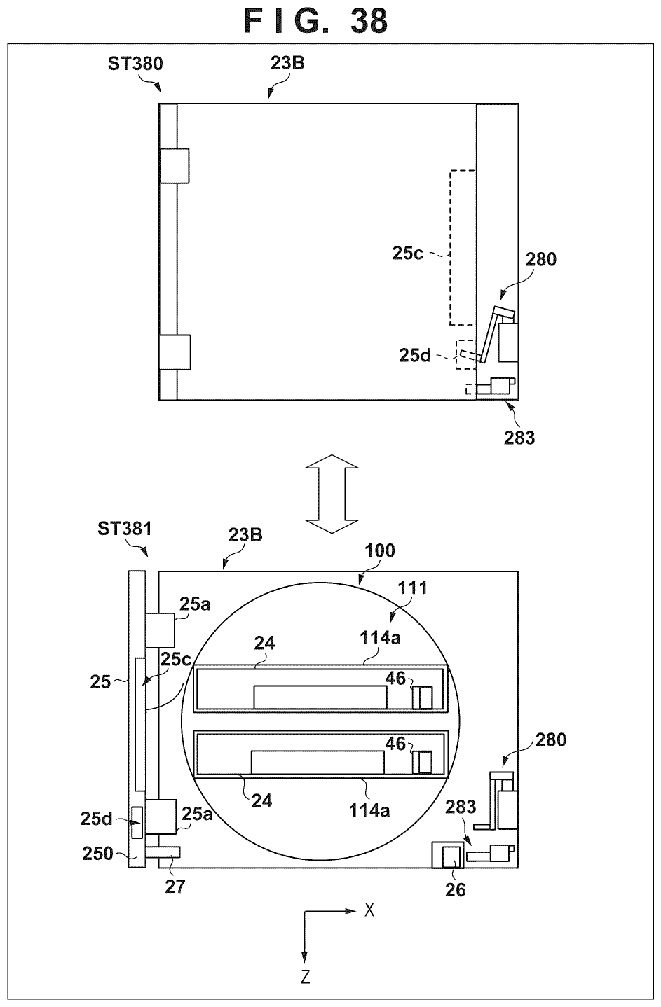

The liquid storage apparatus 20B according to the present embodiment will now be further described with reference to FIG. 38. FIG. 38 is a front view of the storage portion 23B, with the state ST370 illustrating the opening and closing member 25 is a closed state and the state ST371 illustrating the opening and closing member 25 in an open state. Note that FIG. 38 corresponds to a diagram for describing the inside of the frame portion 28, and in the present example, the frame portion 28 is not illustrated.

As illustrated in FIG. 38, the liquid storage apparatus 20B includes the closed lock mechanism 280 described above inside the frame portion 28. The closed lock mechanism 280 is a solenoid lock, for example. The closed lock mechanism 280 switches from a locked state that locks the opening and closing member 25 in the closed state to a lock released state of the opening and closing member 25 via control by the control unit 32 on the basis of the operation unit 281 receiving a release operation, for example. The closed lock mechanism 280 locks the opening and closing of the opening and closing member 25 by being inserted into a recess portion 25d provided on a side wall portion 250 of the opening and closing member 25 in the locked state as illustrated in a state ST380.

The liquid storage apparatus 20B is provided with a biasing member 283 that biases the opening and closing member 25 in the opening direction. As illustrated in a state ST381, after the lock of the closed lock mechanism 280 is released, the opening and closing member 25 is put in an open state by the biasing of the biasing member 283.

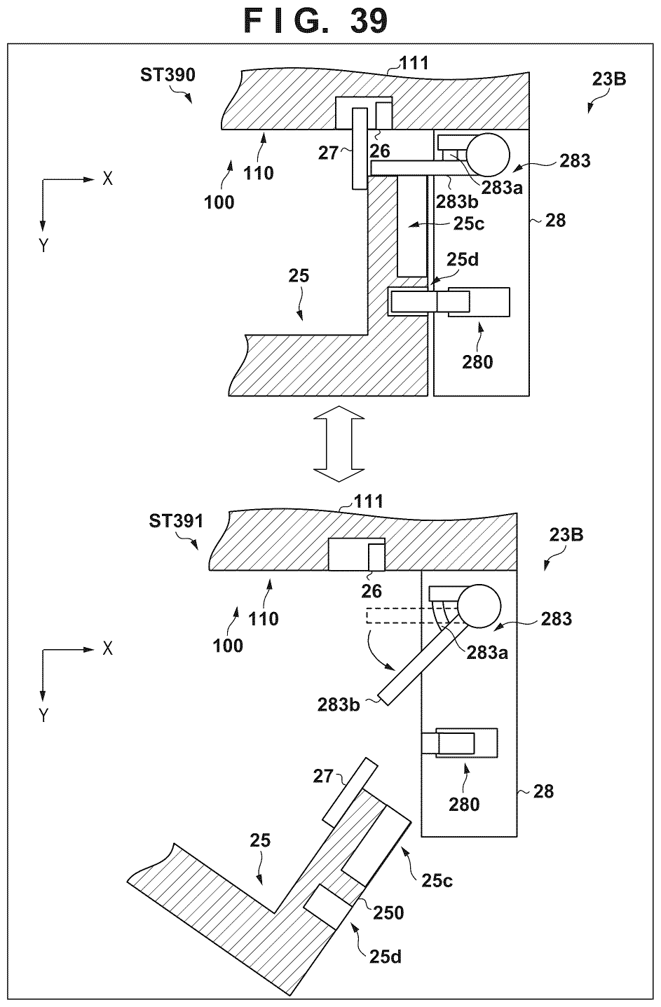

Here, FIG. 39 will be referenced. FIG. 39 is a partial cross-sectional view of the storage portion 23B, with a state ST390 illustrating a state in which the opening and closing member 25 is closed and locked by the closed lock mechanism 280. Also, a state ST391 illustrates a state in which the lock of the opening and closing member 25 of the closed lock mechanism 280 is released and the opening and closing member 25 is opened.

As illustrated in FIG. 39, the biasing member 283 is provided with an elastic member 283a and a contact portion 283b, for example. The elastic member 283a is a member such as a spring that can extend and contract in the opening direction of the opening and closing member 25. The contact portion 283b comes into contact with the end portion of the opening and closing member 25 by being biased by the elastic member 283a in the opening direction of the opening and closing member 25. As illustrated in the state ST390, the opening and closing member 25 is in the closed state and locked by the closed lock mechanism 280, with the biasing by the biasing member 283 restricted. When the closed lock mechanism 280 is put in the lock released state, as illustrated in the state ST391, the opening and closing member 25 opens in the opening direction pushed by the biasing member 283.

Also, in the present embodiment, the opening and closing member 25 is provided with an operation portion 25c that can be operated when the opening and closing member 25 is in the open state opening the opening portion 114a. The operation portion 25c is a portion that can be used by the user as a handle when opening and closing the opening and closing member 25. The operation portion 25c is an indent formed in the side wall of the opening and closing member 25, for example. Also, the operation portion 25c is provided at a position where it cannot be operated when the opening and closing member 25 is in the closed state as illustrated in the state ST390. In other words, the operation portion 25c is provided at a position facing the storage unit 110 when the opening and closing member 25 is in the closed state. This can prevent the user forcibly operating the opening and closing member 25 when the opening and closing member 25 is locked. Also, since the opening and closing member 25 is opened by the biasing member 283 when the lock of the opening and closing member 25 is released, the user-friendliness can be increased.

### Control Circuit Processing Example

Control of rotation by the control unit 32 according to the present embodiment will now be described with reference to FIGS. 40A and 40B. FIG. S. 40A and 40B are flowcharts illustrating an example of processing executed by the control unit 32. The processing of FIGS. 40A and 40B is executed by the control module of the control unit 32 loading a control program stored in the memory such as a ROM onto the RAM and executing the control program.

In step S300, the control unit 32 determines the rotation stop condition relating to the state of the opening and closing member 25. The present processing will be described with reference to FIG. 41. FIG. 41 is a flowchart illustrating an example of processing executed by the control unit 32. The processing of FIG. 41 is executed by the control module of the control unit 32 loading a control program stored in the memory such as a ROM onto the RAM and executing the control program.

In step S400, the control unit 32 determines whether or not the operation unit 281 has received a release operation. In a case where a release operation has been received, the control unit 32 proceeds to step S401. However, in a case where a release operation has not been received, the control unit 32 proceeds to step S402. In step S401, the control unit 32 determines that the rotation stop condition is satisfied. In step S402, the control unit 32 determines that the rotation stop condition is not satisfied. In this manner, in the present embodiment, the rotation stop condition for the control unit 32 to stop the rotation of the storage unit 110 by the drive unit 130 is the operation unit 281 receiving a release operation.

In step S301, the control unit 32 determines whether or not the rotation stop condition is satisfied. In a case where the control unit 32 determines that the rotation stop condition is satisfied, the control unit 32 proceeds to step S302. However, in a case where the control unit 32 determines that the rotation stop condition is not satisfied, the control unit 32 executes the processing of step S300 again. In step S301, specifically, the control unit 32 executes the present determination on the basis of the processing result of step S400.

In step S302, the control unit 32 performs control to cause the display unit 282 to display the predetermined display described above. The control unit 32, for example, may perform control so that at least one of the light-emitting element 282a and the light-emitting element 282b flashes.

The processing of steps S303 to S306 are similar to the processing of steps S102 to S105 of FIG. 35 and thus will not be described.

In step S307, the control unit 32 performs control to restrict the rotation of the storage unit 110 by the drive unit 130. Specifically, for example, the control unit 32 controls the drive unit 130 to drive the motor 131 in a weak magnetic excitation state. According to the present processing, in a case where the rotation of the storage unit 110 is stopped, the drive unit 130 drives the restriction of rotation of the storage unit 110. Accordingly, this can prevent the storage unit 110 rotating when the user pulls out the container support unit 24 from the opening portion 114a. In this manner, the user-friendliness when replacing the storage container 200 can be further increased.

In step S308, the control unit 32 performs control to release the lock of the opening and closing member 25 by the closed lock mechanism 280. In this manner, in the present embodiment, after the rotation of the storage unit 110 by the drive unit 130 is stopped, the lock of the closed lock mechanism 280 is released. In other words, after the rotation is stopped, the opening and closing member 25 can be opened in the opening direction. Via such operations, the user-friendliness for the user when replacing the storage container 200 can be increased.

In step S309, the control unit 32 performs control to remove the predetermined display by the display unit 282.

Steps S310 to S312 are similar to the processing of steps S106 to S108 of FIG. 35 and thus will not be described.

In step S313, the control unit 32 issues a warning. In other words, in a case where, after the rotation stop condition is satisfied and the rotation of the storage unit 110 by the drive unit 130 is stopped, the sensor 26 has not detected the closed state within the predetermined amount of time, a warning is issued by the control unit 32. The warning may be a notification prompting the user to put the opening and closing member 25 in the closed state. In the present embodiment, the control unit 32 may issue a warning by flashing the light-emitting elements 282a and 282b, for example. Also, the warning may be a notification prompting the user to perform stirring by manually rotating the storage container 200. In step S313, the control unit 32 may perform control to display a warning on the display (not illustrated). In step S313, the control unit 32 may perform control to notify the user of the warning via the speaker (not illustrated).

In step S314, the control unit 32 performs control to lock the opening and closing member 25 via the closed lock mechanism 280. The processing of steps S315 to S317 are similar to the processing of steps S110 to S112 of FIG. 35 and thus will not be described.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-072925, filed Apr. 26, 2024, which is hereby incorporated by reference herein in its entirety.

What is claimed is:

1. A liquid storage apparatus comprising:
a stirring portion including a storage unit configured to store liquid and a drive unit configured to drive the storage unit; and
a storage portion configured to store the stirring portion, the storage portion being opened and closed by an opening and closing member, wherein
in a case where a stop condition relating to a state of the opening and closing member is satisfied, rotation of the storage unit by the drive unit is stopped.

2. The liquid storage apparatus according to claim 1, further comprising: a first detection unit configured to detect an open/closed state of the opening and closing member, wherein
the stop condition includes the open/closed state detected by the first detection unit being an open state.

3. The liquid storage apparatus according to claim 2, wherein in a case where, after rotation of the storage unit is stopped due to the stop condition being satisfied, a restart condition relating to a state of the opening and closing member is satisfied, rotation of the storage unit by the drive unit is restarted, and
the restart condition includes the open/closed state detected by the first detection unit being a closed state.

4. The liquid storage apparatus according to claim 1, wherein the storage unit includes
a storage member configured to store a storage container of the liquid, and
an opening portion where the storage container is inserted and removed into/from the storage member, wherein
the opening and closing member is disposed covering the opening portion when in a closed state.

5. The liquid storage apparatus according to claim 4, wherein the storage container is stored in the storage member placed on a tray, and
the storage container is inserted and removed into/from the opening portion while placed on the tray.

6. The liquid storage apparatus according to claim 5, wherein in a case where a stop condition relating to a state of the opening and closing member is satisfied, rotation of the storage unit is stopped to put the tray in a horizontal orientation.

7. The liquid storage apparatus according to claim 5, wherein the storage unit includes a tray lock mechanism configured to lock the tray in the opening portion.

8. The liquid storage apparatus according to claim 7, further comprising: a second detection unit configured to detect a locked state and a released state of the tray by the tray lock mechanism,
a tube extending from the storage unit and forming a flow path for liquid discharged from the storage unit, and
a flow path valve that can switch between opening and closing the tube, wherein
in a case where the released state is detected by the second detection unit, the flow path valve closes the tube.

9. The liquid storage apparatus according to claim 2, further comprising: a notification unit configured to issue a warning in a case where, after the stop condition is satisfied and rotation of the storage unit by the drive unit is stopped, the opening and closing member being in a closed state is not detected by the first detection unit within a predetermined amount of time.

10. The liquid storage apparatus according to claim 1, further comprising: a closed lock mechanism configured to lock the opening and closing member in a closed state, and
an operation unit configured to receive a release operation for locking of the opening and closing member by the closed lock mechanism, wherein
the stop condition includes the operation unit receiving the release operation.

11. The liquid storage apparatus according to claim 10, wherein after rotation of the storage unit by the drive unit is stopped, locking by the closed lock mechanism is released.

12. The liquid storage apparatus according to claim 11, further comprising: a display unit configured to display a predetermined display until locking by the closed lock mechanism is released in a case where the operation unit receives the release operation.

13. The liquid storage apparatus according to claim 12, wherein the display unit includes a first light-emitting element provided adjacent to the operation unit.

14. The liquid storage apparatus according to claim 12, further comprising: a frame portion provided adjacent to the opening and closing member in a case where the opening and closing member is in a closed state, wherein
the storage unit includes
a storage member configured to store a storage container of the liquid, and
an opening portion where the storage container is inserted and removed into/from the storage member, and
the display unit includes
a second light-emitting element disposed on the frame portion at a position aligned with the opening portion in a case where the opening portion has a horizontal orientation.

15. The liquid storage apparatus according to claim 1, wherein the drive unit drives restriction of rotation of the storage unit in a case where rotation of the storage unit is stopped.

16. The liquid storage apparatus according to claim 10, further comprising: a biasing member configured to bias the opening and closing member in an opening direction, wherein
the opening and closing member is biased in the opening direction by the biasing member after locking by the closed lock mechanism is released.

17. The liquid storage apparatus according to claim 16, wherein the opening and closing member includes an operation portion configured to be operable when the opening and closing member is in an open state, wherein
the operation portion is provided at an inoperable position when the opening and closing member is in the closed state.

18. A liquid stirring apparatus stored in a storage portion open and closed by an opening and closing member comprising:
a storage unit configured to store liquid; and
a drive unit configured to rotate the storage unit, wherein
in a case where a stop condition relating to a state of the opening and closing member is satisfied, rotation of the storage unit by the drive unit is stopped.

19. A control method for a liquid storage apparatus provided with a stirring portion including a storage unit configured to store liquid and a drive unit configured to rotate the storage unit and a storage portion configured to store the stirring portion, the storage portion being opened and closed by an opening and closing member, comprising:
in a case where a stop condition relating to a state of the opening and closing member is satisfied, stopping rotation of the storage unit by the drive unit.
